(19) United States
(12) Patent Application Publication
(10) Pub. No.: US 2026/0248127 A1
(43) Pub. Date: Aug. 27, 2026

(54) IMPROVED PESTICIDAL COMPOSITIONS AND PEST CONTROL METHODS

(71) Applicant: BIO-GENE TECHNOLOGY LIMITED, Melbourne, Victoria (AU)

(72) Inventors: Peter MAY, Melbourne (AU); Robert KLUPACS, Melbourne (AU)

(21) Appl. No.: 18/877,929

(22) PCT Filed: Jun. 23, 2023
(86) PCT No.: PCT/AU2023/050579

§ 371 Date: Dec. 20, 2024

(30) Foreign Application Priority Data
Jun. 24, 2022 (AU) 2022901767
Apr. 23, 2023 (AU) 2023901199

(51) Int. Cl. A01N 35/06; A01N 35/10; A01N 53/00; A01P 7/04

(52) U.S. Cl. CPC A01N 35/06; A01N 35/10; A01N 53/00; A01P 7/04

(57) ABSTRACT

The present invention relates to methods for controlling winged insect pests, comprising exposing the pests to an effective amount of a combination of a β-diketone compound and a least one second pesticide selected from a pyrethroid or a pyrethrin, wherein both the β-diketone compound and the at least one second pesticide is used in a sub-effective amount. It also relates to composition for controlling winged insect pests, comprising a β-diketone compound and at least one second pesticide selected from a pyrethroid or a pyrethrin, wherein both of the β-diketone compound and the at the least one pyrethroid or pyrethrin are included in a sub-effective amount.

### RELATED APPLICATIONS

This application claims the benefit of Australian Provisional Patent Application No. 2022901767 filed on 24 Jun. 2022, and Australian Provisional Patent Application No. 2023901199 filed on 23 Apr. 2023, both of which are incorporated herein by reference in their entireties.

### FIELD OF THE INVENTION

This invention relates generally to methods and compositions for controlling winged insect pests. More particularly, the present invention relates to methods and compositions for controlling winged insect pests comprising the use of a combination of a β-diketone compound and at least one second pesticide selected from a pyrethroid or a pyrethrin.

### BACKGROUND OF THE INVENTION

Effective insect control is essential across many industries, not least of all in agriculture in the production of food and livestock. Ineffective insect control and insect infestation can result in the complete destruction of a crop and decimation of an animal population through insect feeding and the spread of disease and infection. Domestic insect control is similarly essential to mitigate the spread of insect-borne infection and diseases.

Winged insects in particular are the focus of many insect control strategies. Winged insects with the ability to fly can be particularly problematic due to their ability to infest a wider area and migrate to new areas. Winged insects also often reproduce through a lifecycle including larvae which can be particularly destructive to crops through feeding and can be parasitic in animal populations and give rise to health concerns in domestic environments. Winged insects also carry many infections and diseases which are dangerous to humans and animals. The prime example is the mosquito, thought to be the world's number one cause of death in humans through the infections and diseases that they carry and transmit.

Synthetic insecticides are relied upon most often for insect control. Synthetic insecticides having varying modes of action have been used for decades in the control of insect pests. However, a number of problems are associated with synthetic insecticides, including the development of resistance in the target pest population, toxicity to animals or humans, and environmental toxicity resulting from non-biodegradability, environmental persistence and contamination of waterways. As a result, a number of insecticides that have been successfully used in the past are now being used less frequently or not at all. This has reduced the number of insecticides available to control insect pests.

Resistance in target populations is a particular problem. It has been estimated that up to 1000 pest species have developed resistance to one or more pesticides since 1945. Attempts to combat this have included the use of increased amounts of insecticides to overcome emerging incidences of resistance, but this has only exacerbated the other problems including toxicity, and while it can be an effective strategy for a time, it can eventually accelerate the development of resistance in insect populations.

A case in point is the use of pyrethroids. Insect control has been heavily dependent on pyrethroids for many years, and incidence of resistance across many insect species is now apparent and increasing. In fact, some species and strains of insect are reported to be completely resistant to one or more pyrethroids. There are few existing or emerging suitable alternatives.

It would thus be advantageous to provide new and alternative insecticide compositions and methods to combat at least one of the problems above, for example which may improve control of insects, and especially winged insects, at potentially reduced rates of application.

### SUMMARY OF THE INVENTION

The present invention is predicated at least in part on the discovery that β-diketone compounds as described herein are particularly effective in the control of winged insects when used in combination with a pyrethroid or a pyrethrin. This discovery has been reduced to practice in the pest-controlling compositions and methods described herein.

In one aspect, the present invention provides a method for controlling winged insect pests, comprising exposing the pests to an effective amount of a combination of a β-diketone compound of formula (I):

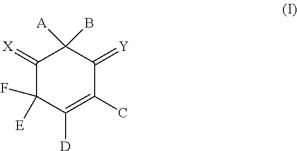

wherein
X and Y are each independently selected from oxygen, sulfur —N—R₄ or one of C═X and C═Y is CH₂;
A is (C═O)R₁, (C═S)R₁, OR₂, SR₂, (CR₃NR₄R₅), C(R₃)₂OR₂, NR₄R₅, (C═N—R₄)R₁, N═O, N(═O)₂, NR₄OR₂ or SO₄R₂;
B is H, C₁-C₁₀ alkyl, C₂-C₁₀ alkenyl, aryl or heteroaryl;
C, D, E and F are each independently selected from H, C₁-C₁₀ alkyl, C₂-C₁₀ arylalkyl, C₃-C₆ cycloalkyl, C₂-C₁₀ alkenyl, C₂-C₁₀ heteroarylalkyl, C₂-C₁₀ haloalkyl, C₂-C₁₀ dihaloalkyl, C₂-C₁₀ trihaloalkyl, C₂-C₁₀ haloalkoxy, OR₂, SR₂, (CR₃NR₄R₅), NR₄R₅, (C═N—R₄)R₁, N═O, N(═O)₂, NR₄OR₂ and SO₄R₂;
R₁ is selected from H, C₁-C₁₀ alkyl, C₂-C₁₀ arylalkyl, C₃-C₆ cycloalkyl, C₂-C₁₀ alkenyl, C₂-C₁₀ heteroarylalkyl, C₁-C₁₀ haloalkyl, C₁-C₁₀ dihaloalkyl, C₂-C₁₀ trihaloalkyl, C₂-C₁₀ haloalkoxy, C₁-C₁₀ hydroxyalkyl, C₁-C₁₀ thioalkyl, C₁-C₁₀ nitroalkyl, OR₂, SR₂, (CR₃NR₄R₅), NR₄R₅, (C═N—R₄)R₆, N═O, N(═O)₂, NR₄OR₇ and SO₄R₇;
R₂ is selected from H, C₁-C₁₀ alkyl, C₂-C₁₀ arylalkyl, C₃-C₆ cycloalkyl, C₂-C₁₀ alkenyl, C₂-C₁₀ heteroarylalkyl, C₂-C₁₀ haloalkyl, C₂-C₁₀ dihaloalkyl, C₂-C₁₀ trihaloalkyl, (CR₃NR₄R₅), NR₄R₅, (C═N—R₄)R₆, N═O, N(═O) 2 and NR₄OR₇;
R₃ is selected from H, C₁-C₁₀ alkyl, C₂-C₁₀ arylalkyl, C₃-C₆ cycloalkyl, C₂-C₁₀ alkenyl, C₂-C₁₀ heteroarylalkyl, C₂-C₁₀ haloalkyl, C₂-C₁₀ dihaloalkyl, C₂-C₁₀ trihaloalkyl, C₂-C₁₀ haloalkoxy, OR₇, SR₇, (CR₈NR₄R₅), NR₄R₅, (C═N—R₄)R₆, N═O, N(═O)₂, NR₄OR₇ and SO₄R₇;
R₄ and R₅ are independently selected from H, C₁-C₁₀ alkyl, C₂-C₁₀ arylalkyl, C₃-C₆ cycloalkyl, C₂-C₁₀ alkenyl, C₂-C₁₀ heteroarylalkyl, C₂-C₁₀ haloalkyl, C₂-C₁₀ dihaloalkyl, C₂-C₁₀ trihaloalkyl, OR₇ and SR₇;
R₆ is selected from H, C₁-C₁₀ alkyl, C₂-C₁₀ arylalkyl, C₃-C₆ cycloalkyl, C₂-C₁₀ alkenyl, C₂-C₁₀ heteroarylalkyl, C₂-C₁₀ haloalkyl, C₂-C₁₀ dihaloalkyl, C₂-C₁₀ trihaloalkyl, C₂-C₁₀ haloalkoxy, OR₇, SR₇, (CR₈NR₉R₁₀), NR₉N₁₀ and NR₉OR₇;
R₇ is selected from H, C₁-C₁₀ alkyl, C₂-C₁₀ arylalkyl, C₃-C₆ cycloalkyl, C₂-C₁₀ alkenyl, C₂-C₁₀ heteroarylalkyl, C₂-C₁₀ haloalkyl, C₂-C₁₀ dihaloalkyl, C₂-C₁₀ trihaloalkyl;
R₈ is selected from H, C₁-C₁₀ alkyl, C₂-C₁₀ arylalkyl, C₃-C₆ cycloalkyl, C₂-C₁₀ alkenyl, C₂-C₁₀ heteroarylalkyl, C₂-C₁₀ haloalkyl, C₂-C₁₀ dihaloalkyl, C₂-C₁₀ trihaloalkyl, OR₁₁, SR₁₁ and NR₉R₁₀;
R₉ and R₁₀ are independently selected from H, C₁-C₁₀ alkyl, C₂-C₁₀ arylalkyl, C₃-C₆ cycloalkyl, C₂-C₁₀ alkenyl, C₂-C₁₀ heteroarylalkyl, C₂-C₁₀ haloalkyl, C₂-C₁₀ dihaloalkyl, C₂-C₁₀ trihaloalkyl, OR₁₂ and SR₁₂;
R₁₁ and R₁₂ are independently selected from H, C₁-C₁₀ alkyl, C₂-C₁₀ arylalkyl, C₃-C₆ cycloalkyl, C₂-C₁₀ alkenyl, C₂-C₁₀ heteroarylalkyl, C₂-C₁₀ haloalkyl, C₂-C₁₀ dihaloalkyl and C₂-C₁₀ trihaloalkyl;
and at least one second pesticide selected from a pyrethroid or a pyrethrin,
   wherein both the β-diketone compound of formula (I) and the at least one second pesticide is used in a sub-effective amount.

In another aspect, the present invention provides a composition for controlling winged insect pests, comprising a β-diketone compound of formula (I) as defined herein, and at least one second pesticide selected from a pyrethroid or a pyrethrin, wherein both the β-diketone compound and the at least one pyrethroid or pyrethrin are included in a sub-effective amount.

In another aspect, the present invention provides a kit for use in a method for controlling winged insect pests, comprising a β-diketone compound of formula (I) as defined herein, and at least one second pesticide selected from a pyrethroid or a pyrethrin, together with instructions to expose winged insect pests to a combination of the β-diketone compound of formula (I) and the at least one pyrethroid or pyrethrin using both of the β-diketone compound and the pyrethroid or pyrethrin in a sub-effective amount.

### DESCRIPTION OF THE DRAWINGS

FIG. 1 is a graph representing the toxicity of Qcide formulation and Permethrin (SP positive control) to Aedes aegypti LVP (SP-susceptible) strain L3 larvae in larval dose response assay at 24, 48 and 72 hours.

FIG. 2 is a graph representing the toxicity of Qcide formulation and Permethrin (SP positive control) to Aedes aegypti PRS (SP-resistant) strain L3 larvae in larval dose response assay at 24, 48 and 72 hours.

FIG. 3 is a graph representing the toxicity of Qcide formulation and Permethrin (SP positive control) to Aedes aegypti LVP (SP-susceptible) strain 3-5 day old adult female mosquitoes at 24 and 48 hours.

FIG. 4 is a graph representing the toxicity of Qcide formulation and Permethrin (SP positive control) to Aedes aegypti PRS (SP-resistant) strain 3-5 day old adult female mosquitoes at 24 and 48 hours.

FIG. 5 is a graph representing the Toxicity of Qcide formulation and Permethrin and Deltamethrin (SP positive controls) to Aedes aegypti LVP (SP-susceptible) and PRS (SP-resistant) strain L3 larvae in mortality-time assays.

FIG. 6 is a graph representing the dose-mortality assays assessing synergistic action between the synthetic pyrethroid, Permethrin (five dose points) co-administered with Qcide (500 EW) at single dose point of LC₁₀ against Aedes aegypti L3 larvae LVP (SP-susceptible) strain at 24 and 48 hours post exposure.

FIG. 7 is a graph representing the dose-mortality assays assessing synergistic action between the synthetic pyrethroid, Permethrin (five dose points) co-administered with Qcide (500 EW) at single dose point of LC₁₀ against Aedes aegypti L3 larvae PRS (SP-resistant) strain at 24 and 48 hours post exposure.

FIG. 8 is a graph representing the dose-mortality assays assessing synergistic action between the synthetic pyrethroid, Permethrin (five dose points) co-administered with Qcide (500 EW) at single dose point of LC₂₀ against Aedes aegypti L3 larvae LVP (SP-susceptible) strain at 24 and 48 hours post exposure.

FIG. 9 is a graph representing the dose-mortality assays assessing synergistic action between the synthetic pyrethroid, Permethrin (five dose points) co-administered with Qcide (500 EW) at single dose point of LC₂₀ against Aedes aegypti L3 larvae PRS (SP-resistant) strain at 24 and 48 hours post exposure.

FIG. 10 is a graph representing the KD50 & KD90 values and 24-hour Mortality of Musca domestica.

FIG. 11 is photographs of the plastic holding container with mesh at each opening (left, side view on the base of the potter tower spray platform; right, top view).

FIG. 12 is a graph representing the mean percentage knockdown, moribund and mortality of Musca domestica) following spray application of Qcide and pyrethrin combinations as compared with Qcide and pyrethrin individually over a 96-hour period.

### DETAILED DESCRIPTION OF THE INVENTION

Unless defined otherwise, all technical and scientific terms used herein have the same meaning as commonly understood by those of ordinary skill in the art of the invention. Although any methods and materials similar or equivalent to those described herein can be used in the practice or testing of the present invention, preferred methods and materials are described. For the purposes of the present invention, a number of terms are defined throughout.

The present invention contemplates methods and compositions for controlling winged insect pests using a β-diketone compound of formula (I) as described herein and at least one second pesticide selected from a pyrethroid or a pyrethrin.

### β-Diketone Compounds of Formula (I)

### A β-Diketone Compound of Formula (I) is Defined as Follows:

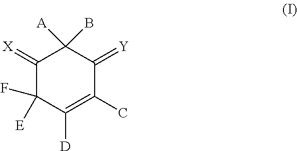

wherein
X and Y are each independently selected from oxygen, sulfur —N—R₄ or one of C═X and C═Y is CH₂;
A is (C═O)R₁, (C═S)R₁, OR₂, SR₂, (CR₃NR₄R₅), C(R₃)₂OR₂, NR₄R₅, (C═N—R₄)R₁, N═O, N(═O)₂, NR₄OR₂ or SO₄R₂;
B is H, C₁-C₁₀ alkyl, C₂-C₁₀ alkenyl, aryl or heteroaryl;
C, D, E and F are each independently selected from H, C₁-C₁₀ alkyl, C₂-C₁₀ arylalkyl, C₃-C₆ cycloalkyl, C₂-C₁₀ alkenyl, C₂-C₁₀ heteroarylalkyl, C₂-C₁₀ haloalkyl, C₂-C₁₀ dihaloalkyl, C₂-C₁₀ trihaloalkyl, C₂-C₁₀ haloalkoxy, OR₂, SR₂, (CR₃NR₄R₅), NR₄R₅, (C═N—R₄)R₁, N═O, N(═O)₂, NR₄OR₂ and SO₄R₂;
R₁ is selected from H, C₁-C₁₀ alkyl, C₂-C₁₀ arylalkyl, C₃-C₆ cycloalkyl, C₂-C₁₀ alkenyl, C₂-C₁₀ heteroarylalkyl, C₁-C₁₀ haloalkyl, C₁-C₁₀ dihaloalkyl, C₂-C₁₀ trihaloalkyl, C₂-C₁₀ haloalkoxy, C₁-C₁₀ hydroxyalkyl, C₁-C₁₀ thioalkyl, C₁-C₁₀ nitroalkyl, OR₂, SR₂, (CR₃NR₄R₅), NR₄R₅, (C═N—R₄)R₆, N═O, N(═O)₂, NR₄OR₇ and SO₄R₇;
R₂ is selected from H, C₁-C₁₀ alkyl, C₂-C₁₀ arylalkyl, C₃-C₆ cycloalkyl, C₂-C₁₀ alkenyl, C₂-C₁₀ heteroarylalkyl, C₂-C₁₀ haloalkyl, C₂-C₁₀ dihaloalkyl, C₂-C₁₀ trihaloalkyl, (CR₃NR₄R₅), NR₄R₅, (C═N—R₄)R₆, N═O, N(═O) 2 and NR₄OR₇;
R₃ is selected from H, C₁-C₁₀ alkyl, C₂-C₁₀ arylalkyl, C₃-C₆ cycloalkyl, C₂-C₁₀ alkenyl, C₂-C₁₀ heteroarylalkyl, C₂-C₁₀ haloalkyl, C₂-C₁₀ dihaloalkyl, C₂-C₁₀ trihaloalkyl, C₂-C₁₀ haloalkoxy, OR₇, SR₇, (CR₈NR₄R₅), NR₄R₅, (C═N—R₄)R₆, N═O, N(═O)₂, NR₄OR₇ and SO₄R₇;
R₄ and R₅ are independently selected from H, C₁-C₁₀ alkyl, C₂-C₁₀ arylalkyl, C₃-C₆ cycloalkyl, C₂-C₁₀ alkenyl, C₂-C₁₀ heteroarylalkyl, C₂-C₁₀ haloalkyl, C₂-C₁₀ dihaloalkyl, C₂-C₁₀ trihaloalkyl, OR₇ and SR₇;
R₆ is selected from H, C₁-C₁₀ alkyl, C₂-C₁₀ arylalkyl, C₃-C₆ cycloalkyl, C₂-C₁₀ alkenyl, C₂-C₁₀ heteroarylalkyl, C₂-C₁₀ haloalkyl, C₂-C₁₀ dihaloalkyl, C₂-C₁₀ trihaloalkyl, C₂-C₁₀ haloalkoxy, OR₇, SR₇, (CR₈NR₉R₁₀), NR₉N₁₀ and NR₉OR₇;
R₇ is selected from H, C₁-C₁₀ alkyl, C₂-C₁₀ arylalkyl, C₃-C₆ cycloalkyl, C₂-C₁₀ alkenyl, C₂-C₁₀ heteroarylalkyl, C₂-C₁₀ haloalkyl, C₂-C₁₀ dihaloalkyl, C₂-C₁₀ trihaloalkyl;
R₈ is selected from H, C₁-C₁₀ alkyl, C₂-C₁₀ arylalkyl, C₃-C₆ cycloalkyl, C₂-C₁₀ alkenyl, C₂-C₁₀ heteroarylalkyl, C₂-C₁₀ haloalkyl, C₂-C₁₀ dihaloalkyl, C₂-C₁₀ trihaloalkyl, OR₁₁, SR₁₁ and NR₉R₁₀;
R₉ and R₁₀ are independently selected from H, C₁-C₁₀ alkyl, C₂-C₁₀ arylalkyl, C₃-C₆ cycloalkyl, C₂-C₁₀ alkenyl, C₂-C₁₀ heteroarylalkyl, C₂-C₁₀ haloalkyl, C₂-C₁₀ dihaloalkyl, C₂-C₁₀ trihaloalkyl, OR₁₂ and SR₁₂; and
R₁₁ and R₁₂ are independently selected from H, C₁-C₁₀ alkyl, C₂-C₁₀ arylalkyl, C₃-C₆ cycloalkyl, C₂-C₁₀ alkenyl, C₂-C₁₀ heteroarylalkyl, C₂-C₁₀ haloalkyl, C₂-C₁₀ dihaloalkyl and C₂-C₁₀ trihaloalkyl.

As used herein, the term “alkyl” refers to straight chain or branched saturated hydrocarbon group and having from 1 to 10 carbon atoms. An alkyl group may have a specified number of carbon atoms, for example, C₁-C₆ alkyl includes alkyl groups having 1, 2, 3, 4, 5 or 6 carbon atoms in a linear or branched arrangement. Examples of suitable alkyl groups include, but are not limited to, methyl, ethyl, n-propyl, i-propyl, n-butyl, i-butyl, t-butyl, n-pentyl, 2-methylbutyl, 3-methylbutyl, 4-methylbutyl, n-hexyl, 2-methylpentyl, 3-methylpentyl, 4-methylpentyl, 5-methylpentyl, 2-ethylbutyl, 3-ethylbutyl, heptyl, octyl, nonyl and decyl.

As used herein, the term “cycloalkyl” refers to a saturated cyclic hydrocarbon. A cycloalkyl group may have a specified number of carbon atoms, for example, C₃-C₆ cycloalkyl includes cycloalkyl groups having 3, 4, 5 or 6 carbon atoms. Examples of suitable cycloalkyl groups include, but are not limited to, cyclopropyl, cyclobutyl, cyclopentyl and cyclohexyl.

As used herein, the term “alkenyl” refers to a straight-chain or branched hydrocarbon group having one or more double bonds between carbon atoms and having from 2 to 10 carbon atoms. An alkenyl group may have a specified number of carbon atoms, for example, C₂-C₆ alkenyl includes alkenyl groups having 2, 3, 4, 5 or 6 carbon atoms in a linear or branched arrangement. Examples of suitable alkenyl groups include, but are not limited to, ethenyl, propenyl, isopropenyl, butenyl, butadienyl, pentenyl, pentadienyl, hexenyl, hexadienyl, heptenyl, octenyl, nonenyl and decenyl.

As used herein, the term “aryl” refers to a stable, monocyclic, bicyclic or tricyclic carbon ring system of up to 7 atoms in each ring, wherein at least one ring is aromatic. Examples of such aryl groups include, but are not limited to, phenyl, naphthyl, tetrahydronaphthyl, indanyl, fluorenyl, phenanthrenyl, biphenyl and binaphthyl.

As used herein, the term “heteroaryl” refers to a stable monocyclic, bicyclic or tricyclic ring of up to 7 atoms in each ring, wherein at least one ring is aromatic, and at least one ring contains from 1 to 4 heteroatoms selected from the group consisting of O, N and S. Examples of suitable heteroaryl groups include, but are not limited to, acridinyl, carbazolyl, cinnolinyl, quinoxalinyl, quinazolinyl, pyrazolyl, indolyl, isoindolyl, 1H,3H-1-oxoisoindolyl, benzotriazolyl, furanyl, thienyl, thiophenyl, benzothienyl, benzofuranyl, benzodioxane, benzodioxin, quinolinyl, isoquinolinyl, oxazolyl, isoxazolyl, imidazolyl, pyrazinyl, pyridazinyl, pyridinyl, pyrimidinyl, pyrrolyl, tetrahydroquinolinyl, thiazolyl, isothiazolyl, 1,2,3-triazolyl, 1,2,4-triazolyl, 1,2,4-oxadiazolyl, 1,2,4-thiadiazolyl, 1,3,5-triazinyl, 1,2,4-triazinyl, 1,2,4,5-tetrazinyl and tetrazolyl. Particular heteroaryl groups have 5- or 6-membered rings, such as pyrazolyl, furanyl, thienyl, oxazolyl, indolyl, isoindolyl, 1H,3H-1-oxoisoindolyl, isoxazolyl, imidazolyl, pyrazinyl, pyridazinyl, pyridinyl, pyrimidinyl, pyrrolyl, thiazolyl, isothiazolyl, 1,2,3-triazolyl, 1,2,4-triazolyl and 1,2,4-oxadiazolyl and 1,2,4-thiadiazolyl.

As used herein, the term “haloalkyl” refers to an alkyl group in which one or more hydrogen atoms is substituted with a halo atom. A haloalkyl group may have a specified number of halo substitutions, for example, dihaloalkyl (two) and trihaloalkyl (three). Examples of suitable haloalkyl groups include, but are not limited to, fluoromethyl, difluoromethyl, trifluoromethyl, 1-fluoroethyl, 2-fluoroethyl, 1,1-difluoroethyl, 2,2-fluoroethyl, 1,1,2-trifluoroethyl, 2,2,2-trifluoroethyl, 3-fluoropropyl, 3,3-difluoropropyl, 3,3,3-trifluoropropyl, 4-fluorobutyl, 4,4-difluorobutyl, 4,4,4-trifluorobutyl, 5-fluoropentyl, 5,5-difluoropentyl, 5,5,5-trifluoropentyl, 6-fluorohexyl, 6,6-difluorohexyl or 6,6,6-trifluorohexyl, chloromethyl, dichloromethyl, trichloromethyl, 1-chloroethyl, 2-chloroethyl, 1,1-dichloroethyl, 2,2-chloroethyl, 1,1,2-trichloroethyl, 2,2,2-trichloroethyl, 3-chloropropyl, 3,3-dichloropropyl, 3,3,3-trichloropropyl, 4-chlorobutyl, 4,4-dichlorobutyl, 4,4,4-trichlorobutyl, 5-chloropentyl, 5,5-dichloropentyl, 5,5,5-trichloropentyl, 6-chlorohexyl, 6,6-dichlorohexyl or 6,6,6-trichlorohexyl, bromomethyl, dibromomethyl, tribromomethyl, 1-bromoethyl, 2-bromoethyl, 1,1-dibromoethyl, 2,2-dibromoethyl, 1,1,2-tribromoethyl, 2,2,2-tribromoethyl, 3-bromopropyl, 3,3-dibromopropyl, 3,3,3-tribromopropyl, 4-bromobutyl, 4,4-dibromobutyl, 4,4,4-tribromobutyl, 5-bromopentyl, 5,5-dibromopentyl, 5,5,5-tribromopentyl, 6-bromohexyl, 6,6-dibromohexyl or 6,6,6-tribromohexyl and the like.

The term “halo” refers to fluorine, chlorine, bromine and/or iodine.

As used herein, the term “hydroxyalkyl”, “thioalkyl” and “nitroalkyl” each refer to an alkyl group in which one or more hydrogen atoms is substituted with a hydroxyl group, a thiol group or a nitro group, respectively.

As used herein, the term “alkoxy” refers to an oxygen substituent that is substituted with an alkyl group. Examples of suitable alkoxy groups include, but are not limited to, —OCH₃, —OCH₂CH₃, —O(CH₂)₂CH₃, —OCH(CH₃)₂, —O(CH₂)₃CH₃, —OCH₂CH(CH₃)₂, —OC(CH₃)₃, —O(CH₂)₄CH₃ and —O(CH₂)₅(CH₃).

A compound of formula (I) classified as a β-diketone herein is with reference to the core cyclohexen β-dione motif of the structural formula which defines a compound of formula (I). Notwithstanding, β-diketone compounds of formula (I) may exist in tautomeric forms involving the core cyclohexen β-dione motif, and many are capable of existing in differing geometric isomers and diastereomers. The β-diketone compounds of the present invention are taken to include all tautomers, individual isomers and mixtures of isomers.

Similarly, β-diketone compounds of formula (I) may exist as solvates, for example, hydrates, and/or as salts. Examples of suitable salts include, but are not limited to, monovalent metal salts such as sodium and potassium salts, divalent metal salts such as calcium, magnesium, iron and copper salts, and ammonium salts such as isopropyl ammonium, trialkyl and tetraalkylammonium salts. Examples of suitable salts also include agriculturally acceptable salts including salts of agriculturally acceptable inorganic acids such as hydrochloric, sulphuric, phosphoric, nitric, carbonic, boric, sulfamic, and hydrobromic acids, or salts of agriculturally acceptable organic acids such as acetic, propionic, butyric, tartaric, maleic, hydroxymaleic, fumaric, maleic, citric, lactic, mucic, gluconic, benzoic, succinic, oxalic, phenylacetic, methanesulphonic, toluenesulphonic, benzenesulphonic, salicyclic, sulphamic, aspartic, glutamic, edetic, stearic, palmitic, oleic, lauric, pantothenic, tannic, ascorbic and valeric acids. The β-diketone compounds of the present invention are taken to include all solvates and salts thereof.

The β-diketone compounds of the present invention may be prepared according to methods analogous to those known in the art. Exemplary methods are disclosed for example in EP-A-338992, EP-A-336898, U.S. Pat. Nos. 4,202,840, 4,869,748, EP-A-186118, EP-A-186119, EP-A-186120, U.S. Pat. Nos. 4,695,673, 4,780,127, 4,921,526, 5,006,150, 5,545,607, 5,925,795, 5,990,046, 6,218,579, EP-A-249150, EP-A-137963, EP-A-394889, EP-A-506907 and EP-B-135191.

The β-diketone compounds of the present invention may be obtained from natural sources, and particularly from volatile oil-bearing plants, for example by extraction. Where available, this is preferred. Volatile oil-bearing plants which may produce a β-diketone compounds of formula (I) may be from the family Myrtaceae, and particularly of the genus Eucalyptus, Baeckea and Melaleuca. Representative and preferred plant species include (for tasmanone) Eucalyptus tenuiramis, Baeckea frutescens (also agglomerone), Eucalyptus risdonii and Eucalyptus cloeziana; (for lateriticone) Eucalyptus lateritica; and (for platyphyllol) Melaleuca cajuputi. Extraction methods are known to those of skill in the art and include for example steam distillation of plant biomass.

In preferred embodiments for producing extracts containing tasmanone, the plant is selected from one or more of the Eucalyptus cloeziana varieties denoted BGTECLD29, BGTECLD14 and BGTECLD30 the subject of Australian Plant Breeder Right Application Nos. 2022/268 filed 29 Nov. 2022, 2022/267 filed 29 Nov. 2022 and 2022/266 filed 26 Nov. 2022, respectively. Samples of BGTECLD29, BGTECLD14 and BGTECD30 are held at James Cook University, Smithfield, Cairns QLD 4870, and at Plant Biotech, 41 Menary Road, Coes Creek QLD 4560.

The β-diketone compounds of formula (I) may be used as substantially purified synthetic compound, substantially purified isolated compound, or in crude extract, and may be used as obtained, either directly in the methods described herein or formulated into a composition for use in the methods described herein. When used as a crude extract, preferably the β-diketone compound of formula (I) is present in the crude extract in a high proportion; that is, at least about 70 wt %, preferably at least about 80 wt %, 85 wt % or 90 wt %, preferably at least about 91 wt %, 92 wt %, 93 wt %, 94 wt % and more preferably at least about 95 wt %. By “substantially purified” is meant that the β-diketone compound of formula (I) is present in an amount of at least about 97 wt %, preferably at least about 98 wt %, 99 wt %, 99.5 wt %, 99.8 wt % and preferably at least about 99.9 wt %.

Often the plant extract may be a liquid (often an oil) in which case the plant extract may contain a β-diketone compound of formula (I) in an amount of at least about 50 vol % (500 g/L), preferably at least about 55 vol % (550 g/L), 60 vol % (600 g/L), 65 vol % (650 g/L), 70 vol % (700 g/L), 75 vol % (750 g/L) and preferably 80 vol % (800 g/L). In some embodiments, a β-diketone compound of formula (I) is extractable from a plant in an amount of at least about 81 vol % (810 g/L), 82 vol % (820 g/L), 83 vol % (830 g/L), 84 vol % (840 g/L) and even 85 vol % (850 g/L).

Plant extracts may often contain other components and are extracted from the plant along with the β-diketone compound of formula (I) and as such plant extracts are often compositions. In preferred embodiments, the plant extract is a phytochemical extract. By a “phytochemical extract” is meant that the plant extract is a composition containing at least one phytochemical compound that is other than, and in addition to, any one β-diketone compound of formula (I), and that has been extracted from the plant along with the β-diketone compound of formula (I). A phytochemical extract is preferred because, and without wishing to be limited by theory, it is believed that an additional phytochemical may assist in the control of un-emerged pests and reducing un-emerged pest viability, by enhancing the activity of the β-diketone compound of formula (I), even if only marginally. The at least one other phytochemical compound may be one or more of α-/β-phellandrene, cis-/trans-menth-2-en-1-ol, 1,8-cineole, eudesmols, eucaluptol, α-pinene, p-cymene, terpineols, terpinenes, globulol, limonene, β-myrcene, citronellal and linalool.

In preferred embodiments, the β-diketone compound of formula (I) is selected from a compound of structural formula as follows:

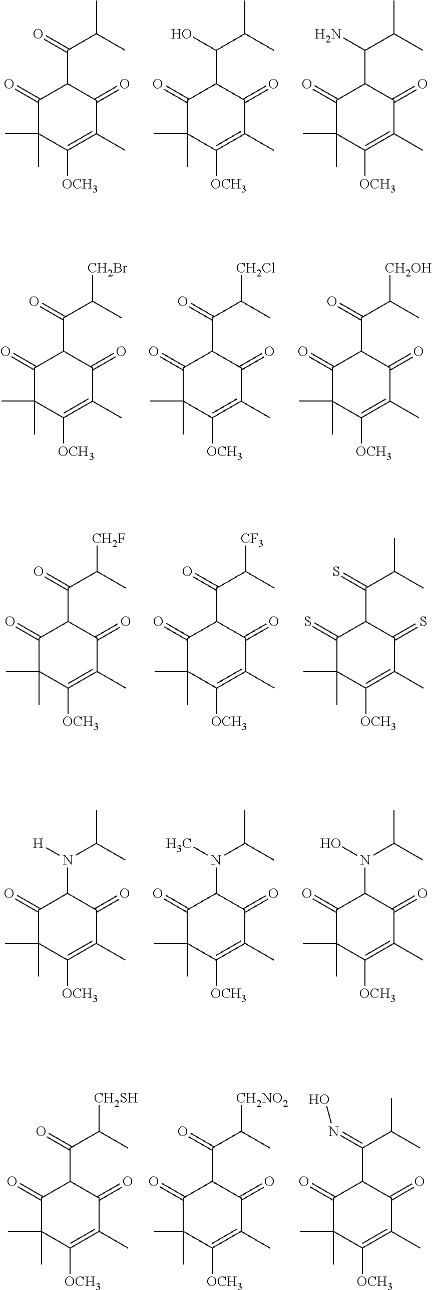

In more preferred embodiments, the β-diketone compound of formula (I) is selected from tasmanone (1-isobutyroyl-4 methoxy-3,5,5-trimethylcyclohex-3-en-2,6-dione), agglomerone (1-isobutyroyl-4-methoxy-5,5-dimethylcyclohex-3-en-2,6-dione), lateriticone (1-valeroyl-4-methoxy-3,5,5-trimethylcyclohex-3-en-2,6-dione), isolateriticone (1-isovaleroyl-4-methoxy-3,5,5-trimethylcyclohex-3-en-2,6-dione) and platyphyllol (6,6-dimethyl-2-acetyl-5-methoxycyclohex-4-ene-1,3-dione).

In most preferred embodiments, the β-diketone compound of formula (I) is tasmanone (1-isobutyroyl-4 methoxy-3,5,5-trimethylcyclohex-3-en-2,6-dione). This is because, of the β-diketone compounds of formula (I), tasmanone is believed to have greatest activity against winged insect pests when used in combination with a pyrethroid or a pyrethrin.

### Pyrethroids and Pyrethrins

As used herein, a “pyrethrin” refers to a compound that is identical to a known natural pyrethrin produced by the plant species Chrysanthemum cineraria folium or C. coccineum, and includes salts, solvates and geometric isomers thereof. The natural pyrethrins include the compounds pyrethrin I, cinerin I, jasmolin I, pyrethrin II, cinerin II and jasmolin II.

In certain preferred embodiments, the one or more second pesticide is a pyrethrin, preferably a mixture of pyrethrins, preferably including at least pyrethrin I and pyrethrin II, and preferably including all six pyrethrins. When a mixture of all six pyrethrins is used, preferably pyrethrin I and pyrethrin II make up a majority of the mixture (i.e. about 50 wt % or more).

As used herein, a “pyrethroid” refers to a synthetic compound with a chemical structure that is similar to a pyrethrin and has a pesticidal mode of action that is the same as a pesticidal mode of action of a pyrethrin. Examples include the compounds acrinathrin, allethrin, bifenthrin, bioallethrin, bioallethrin-S-cyclopentyl, bioresmethrin, cycloprothrin, cyfluthrin, β-cyfluthrin, cyhalothrin, γ-cyhalothrin, λ-cyhalothrin, cypermethrin, α-cypermethrin, β-cypermethrin, θ-cypermethrin, ζ-cypermethrin, cyphenothrin, deltamethrin, dimefluthrin, empenthrin, esfenvalerate, etofenprox, fenpropathrin, fenvalerate, flucythrinate, flumethrin, fluvalinate, tau-fluvalinate, halfenprox, imiprothrin, metofluthrin, permethrin, phenothrin, prallethrin, profluthrin, pyrethrin (pyrethrum), resmethrin, RU15525, silafluofen, tefluthrin, tetramethrin, tralomethrin, transfluthrin and ZX18901.

In certain preferred embodiments, the one or more second pesticide is a pyrethrin, preferably selected from at least pyrethrin I and pyrethrin II, and most preferably a mixture of pyrethrins including at least pyrethrin I and pyrethrin II.

In certain preferred embodiments, the one or more second pesticide is a pyrethroid, preferably selected from permethrin, deltamethrin and cypermethrin, and most preferably permethrin.

### Methods of the Invention

The present invention provides a method for controlling winged insect pests, comprising exposing the pests to an effective amount of a combination of a β-diketone compound of formula (I) as described herein and at least one second pesticide selected from a pyrethrin or a pyrethroid, wherein the β-diketone compound of formula (I) and the at least one second pesticide are used in a sub-effective amount.

As used herein, the term “combination” refers to the β-diketone compound of formula (I) and the at least one pyrethroid or pyrethrin being used together, whether in a single composition or separate compositions or sequentially in separate compositions, such that the biological activity of both compounds in the winged insect pest overlaps or occurs at the same time. In preferred embodiments, the β-diketone compound of formula (I) and the at least one pyrethroid or pyrethrin are used together in a single composition as described herein.

As used herein, the term “controlling” refers to inhibiting the winged insect pest from participating in activities in an environment in population numbers causing it to be a pest in that environment. Control may be by way of expelling winged insect pests from that environment and/or incapacitating winged insect pests. Expelling winged insect pests encompasses reducing or inhibiting infestation and repelling winged insect pests from an environment. Incapacitating winged insect pests encompasses knockdown (KD), killing, or otherwise causing a moribund state.

Control of winged insect pests does not necessarily require completely expelling winged insect pests from an environment or incapacitation of all winged insect pests in an environment. Reducing active population numbers may be sufficient to cause a winged insect pest to cease being pestilent, and for it to thus be controlled, even if some of a population remain present and active. What constitutes control of a winged insect pest may differ between the particular winged insect pest, its population numbers and the environment, and is determinable by one of skill in the art.

In preferred embodiments, the winged insect pests are controlled by being incapacitated. Preferably winged insect pests are incapacitated by knockdown and/or death, preferably death.

Incapacitating winged insect pests may be represented by a time-to-knockdown (or any moribund state), being the time taken for an amount of insecticide that is effective for knockdown of a percentage of an insect population to effectively knockdown that percentage of the insect population following exposure of the winged insect pest population to that amount. Time-to-KD may depend on, for example, the particular winged insect pest, the amount of insecticide used, the environment and the winged insect pest population numbers, but generally speaking, the time-to-KD of an amount of the combination will be less than the time-to-KD of an equivalent amount of each of the β-diketone compound of formula (I) and the at least one pyrethroid or pyrethrin individually.

Winged insect pests may be controlled by applying to the pests or to an environment that hosts or potentially hosts the pests a combination of a β-diketone compound of formula (I) as described herein and at least one second pesticide selected from a pyrethrin or a pyrethroid, so as to expose the pests to a β-diketone compound of formula (I) and at least one second pesticide selected from a pyrethrin or a pyrethroid. As used herein, the term “environment” refers to an environment in which the combination of a β-diketone compound of formula (I) and the at least one pyrethroid or pyrethrin may be applied to expose the winged insect pests to the combination to control the winged insect pests. The environment may be an agricultural environment, a household environment, an industrial environment or another environment that hosts or potentially hosts winged insect pests. An agricultural environment includes environments for growing crops, trees and other plants of commercial importance, and includes the plants, soil and surrounding areas, and agricultural product storage facilities and areas. A household environment includes environments inhabited by humans or animals, including an indoor environment and outdoor environment such as a garden, and includes fittings and furnishings. An industrial environment includes environments which are used for industrial purposes such as manufacture, storage or vending of products, such as warehouses, manufacturing plants, retail outlets and the like, and are generally indoor environments. Other environments may include leisure areas such as parks and stadiums or water areas such as rivers, lakes, ponds or where water may collect or be slow moving or stagnant. In preferred embodiments, the environment is a household or an industrial environment, and preferably an indoor environment.

In an environment, winged insect pests may be exposed to the combination of a β-diketone compound of formula (I) and at least one pyrethroid or pyrethrin by application of that combination to the environment, which may be for example by dispersion in air, application to surfaces or application to an animal, for example by, dipping, spraying, pour-on, washing, fogging or misting, drenching, droplet application or other airborne application methods. In the case of application to an animal, the animal may be a livestock animal, for example cattle, sheep, goats, deer, pigs, camels, llamas, alpacas, chickens and the like, or a companion animal, for example dog, cat, rabbit, guinea pig, hamster, mouse, horse, and the like. In preferred embodiments, the combination of a the β-diketone compound of formula (I) and at least one pyrethroid or pyrethrin is applied by dispersion in air.

As used herein, the term “effective amount” in context of the combination of the β-diketone compound of formula (I) and the at least one pyrethroid or pyrethrin is meant an amount of the combination that is sufficient for controlling the winged insect pests. For example, in the case of incapacitating winged insect pests, an effective amount of the combination may be represented by an LC or an LD amount; that is a concentration or dosage, respectively, that is effective for killing or knockdown (which may be termed a KD amount expressed as a concentration and can be taken to apply to otherwise moribund states) of a percentage of an insect population sufficient for it to cease being a pest. LC, LD and/or KD amounts for any given winged insect pest is determinable by one of skill in the art through routine trials. Depending on, for example, the particular winged insect pest, the environment and the winged insect pest population numbers, this may be, for example, an LC₁₀, LC₁₅, LC₂₀, LC₂₅, LC₃₀, LC₃₅, LC₄₀, LC₄₅, LC₅₀, LC₅₅, LC₆₀, LC₆₅, LC₇₀, LC₇₅, LC₈₀, LC₈₅, LC₉₀ and LC₉₅ amount (or equally an LD or KD amount) of the combination. This may also be an LC₁₀₀ amount (or LD₁₀₀ or KD₁₀₀ amount) when control of the winged insect pests requires killing (or knockdown, or otherwise moribund) of every insect in the insect population.

In preferred embodiments, especially in the case of dangerous and nuisance winged insect pests (for example mosquitos and houseflies), the effective amount of the combination of the β-diketone compound of formula (I) and the at least one pyrethroid or pyrethrin is at least an LC₉₀ amount which may be an LC₉₀, LC₉₁, LC₉₂, LC₉₃, LC₉₄, LC₉₅, LC₉₆, LC₉₇, LC₉₈, LC₉₉ or LC₁₀₀ amount, preferably at least an LC₉₅ amount and more preferably at least an LC₉₉ amount including an LC₁₀₀ amount (and as equally applicable to LD or KD amounts). A similar principle may be applied to expelling winged insect pests from an environment; that is, that an amount is used that results in at least 90% of an exposed insect population being expelled, which may be 90%, 91%, 92%, 93%, 94%, 95%, 96%, 97%, 98%, 99% or 100%, preferably at least 95% and more preferably at least 99%.

The physical amount of the combination that constitutes an effective amount of the combination is dependent on the particular winged insect pest, the level of infestation, its susceptibility to the combination, the type of control desired and the environment to which the combination is to be applied, and is determinable by one of skill in the art. Generally speaking, in an agricultural environment which generally calls for a broadcast application, the amount of the combination in an agricultural environment may be in an amount within the range of about 0.01 to 200 kg/ha, or 0.1 to 150 kg/ha or anywhere from 1 to 100 kg/ha, for example in a broadcast application. In certain preferred embodiments, the amount of the combination may be in an amount within the range of about 50 to 200 kg/ha, or 75 to 150 kg/ha or 90 to 130 kg/ha, or an amount of about 95 kg/ha or 130 kg/ha, for example within the range of about 90 kg/ha to 100 kg/ha or about 125 to 135 kg/ha. In a household or industrial environment, the combination may be applied in an amount within the range of 1 ng/m³ to 1 g/m³, or 1 μg/m³ to 500 mg/m³ or anywhere from 1 mg/m³ to 100 mg/m³, for example in an airborne application.

As used herein, the term “sub-effective amount” in context of each of the β-diketone compound of formula (I) and the at least one pyrethroid or pyrethrin is meant an amount that, when used alone, would not be effective for controlling the winged insect pests. That is, a sub-effective amount is less than an effective amount. For example, in the case of incapacitating winged insect pests, and using the same example as above based on an LC amount, when the effective amount of the combination in controlling the winged insect pests is an LC₁₀₀ amount, a sub-effective amount of each of the β-diketone compound of formula (I) and the at least one pyrethroid or pyrethrin is less than an LC₁₀₀ amount; an LC_{<100} amount, which may be for example an LC₉₉, LC₉₅, LC₉₀, LC₈₅, LC₈₀, LC₇₅, LC₇₀, LC₆₅, LC₆₀, LC₅₅, LC₅₀, LC₄₅, LC₄₀, LC₃₅, LC₃₀, LC₂₅, LC₂₀, LC₁₅ or LC₁₀ amount. Similarly, when the effective amount of the combination is an LC₅₀ amount, a sub-effective amount of each of the β-diketone compound of formula (I) and the at least one pyrethroid or pyrethrin is less than an LC₅₀ amount; an LC_{<50} amount, which may be for example and LC₄₅, LC₄₀, LC₃₅, LC₃₀, LC₂₅, LC₂₀, LC₁₅ or LC₁₀ amount. The same principle is equally applicable to LD or KD amounts. A similar principle may be applied to expelling winged insect pests from an environment; that is, when the effective amount of the combination in controlling the winged insect pests results in 100% of an insect population being expelled, a sub-effective amount of each of the β-diketone compound of formula (I) and the at least one pyrethroid or pyrethrin is an amount that, when used alone, results in less than 100% expulsion of the insect population.

In preferred embodiments, the sub-effective amount of each of the β-diketone compound of formula (I) or the at least one pyrethroid or pyrethrin is a sub-additive amount.

As used herein, a “sub-additive amount” in terms of each of the β-diketone compound of formula (I) or the at least one pyrethroid or pyrethrin is meant an amount of each that, when the effects of each when used alone are added together, would not be effective for controlling the winged insect pests. In other words, a combination effective for controlling winged insect pests that comprises a sub-additive amount of each of the β-diketone compound of formula (I) or the at least one pyrethroid or pyrethrin is a synergistic combination; that is, super-additive. For example, in the case of incapacitating winged insect pests, and using the same example as above based on an LC amount, when the effective amount of the combination in controlling the winged insect pests is an LC₁₀₀ amount, a sub-additive amount of each of the β-diketone compound of formula (I) and the at least one pyrethroid or pyrethrin is an amount that, when the effects of each when used alone are added together, is less than an LC₁₀₀ amount. In other words, and generally speaking, the percentage of an insect population that each of the of the β-diketone compound of formula (I) and the at least one pyrethroid or pyrethrin kills, when used alone, does not amount to control of the winged insect pests. The same principle is equally applicable to LD or KD amounts. A similar principle may be applied to expelling winged insect pests from an environment; that is, when the effective amount of the combination in controlling the winged insect pests results in 100% of an insect population being expelled, a sub-additive amount of each of the β-diketone compound of formula (I) and the at least one pyrethroid or pyrethrin is an amount that, when the percentage population expelled by each when used alone is added together, results in less than 100% expulsion of the insect population.

In preferred embodiments, the amount of the β-diketone compound of formula (I) used in the combination is from about an LC₅ to about an LC₂₅ amount, preferably from about an LC₁₀ to about an LC₂₀ amount. In some preferred embodiments, an LC₁₀ or an LC₂₀ amount is used. In these embodiments using from about an LC₅ to about an LC₂₅ amount of the β-diketone compound of formula (I), the amount of the at least one pyrethrin or pyrethroid is preferably from about an LC₄₀ to about an LC₆₀ amount, preferably from about an LC₄₅ to about an LC₅₅ amount. In some preferred embodiments, an LC₅₀ amount is used. The same principle is equally applicable to LD or KD amounts, and a similar principle in terms of insect population proportions may be applied to expelling winged insect pests from an environment.

In other preferred embodiments, the amount of the β-diketone compound of formula (I) used in the combination is from about an LC₁₅ to about an LC₆₀ amount, preferably from about an LC₂₀ to about an LC₅₅ amount, or from about an LC₂₀ to about an LC₃₀ amount, or from about an LC₄₅ to about an LC₅₅ amount. In some preferred embodiments, an LC₂₅ or an LC₅₀ amount is used. In these embodiments using from about an LC₁₅ to about an LC₆₀ amount of the β-diketone compound of formula (I), the amount of the at least one pyrethrin or pyrethroid is also from about an LC₁₅ to about an LC₆₀ amount, preferably from about an LC₂₀ to about an LC₅₅ amount, or from about an LC₂₀ to about an LC₃₀ amount, or from about an LC₄₅ to about an LC₅₅ amount, and in some preferred embodiments is an LC₂₅ or an LC₅₀ amount. Specific preferred embodiments of the combination includes an LC₂₅ amount of a β-diketone compound of formula (I) with an LC₂₅ amount of the at least one pyrethrin or pyrethroid, an LC₂₅ amount of a β-diketone compound of formula (I) with an LC₅₀ amount of the at least one pyrethrin or pyrethroid, and an LC₅₀ amount of a β-diketone compound of formula (I) with an LC₂₅ amount of the at least one pyrethrin or pyrethroid. These embodiments may represent the greatest synergy. The same principle is equally applicable to LD or KD amounts, and a similar principle in terms of insect population proportions may be applied to expelling winged insect pests from an environment.

In certain preferred embodiments, the amount of the β-diketone compound of formula (I) used in the combination is greater than the amount of the at least one pyrethrin or pyrethroid used in the combination. Depending on the particular winged insect pest, its susceptibility to the combination, the type of control desired and the environment to which the combination is to be applied, the amount may be determined as an amount per insect. For the β-diketone compound of formula (I), this may be an amount of about 500 ng to about 100 μg, or about 1 μg to about 70 μg, or about 10 μg to about 55 μg. For the at least one pyrethrin or pyrethroid, this may be an amount of about 0.05 ng to about 50 μg, or about 10 ng to about 7 μg, or about 50 ng to about 3 μg.

The amount may also be determined as a proportion of a formulation, for example for a broadcast or airborne application to the area of an environment. For example, for an area application rate of a formulation of 100 L/ha, for the β-diketone compound of formula (I), this may be included in an amount of from about 0.5 g/L to about 500 g/L, or from about 10 g/L to about 250 g/L, or from about 25 g/L to about 200 g/L. In some preferred embodiments, the β-diketone compound of formula (I) may be included in an amount of about 60 g/L or about 125 g/L, for example within the range of from about 50 or 55 g/L to about 65 or 70 g/L, or from about 115 or 120 g/L to about 130 or 135 g/L. In these embodiments, for the at least one pyrethrin or pyrethroid, this may be included in an amount of from about 0.1 g/L to about 50 g/L, or from about 1 g/L to about 25 g/L, or from about 5 g/L to about 20 g/L. In some preferred embodiments, the at least one pyrethrin or pyrethroid is included in an amount of about 8 g/L or about 12 g/L, for example within the range of from about 5 to about 10 g/L, or from about 10 to about 15 g/L. For an area application rate of a formulation of 100 L/ha, specific embodiments include a β-diketone compound of formula (I) included in an amount of about 60 g/L or 90 g/L and the at least one pyrethrin or pyrethroid included in an amount of about 8 g/L or about 12 g/L. Equivalencies apply for different application rates; for example for an area application rate of double—200 L/ha—or for an area application rate of half—50 g/L—the amounts may be halved or doubled accordingly, respectively, etc.

The ratio of the β-diketone compound of formula (I) to the at least one pyrethrin or pyrethroid used may be from about 100:50 to 100:0.01 parts, or from about 100:10 to 100:0.1 parts, or from about 100:0.5 parts to 100:5 parts. In certain preferred embodiments, the ratio of the β-diketone compound of formula (I) to the at least one pyrethrin or pyrethroid used is from about 100:30 to 100:0.5 parts, preferably 100:25 to 100:1 parts and preferably 100:20 to 100:5 parts. In certain preferred embodiments, a ratio of about 100:19 parts, 100:13 parts or 100:9 parts β-diketone compound of formula (I) to the at least one pyrethrin or pyrethroid is used.

In certain preferred embodiments, the amount of the combination used to which the winged insect pest is exposed is such that a time-to-KD of at least about 50% of a winged insect pest population is less than about 420 seconds—that is, a time of between 0 and about 420 seconds—preferably a time of about 300 seconds or less, and more preferably a time of about 240 seconds or less or 120 seconds or less. Similarly, the amount of the combination used is preferably such that a time-to-KD of at least about 90% or greater of a winged insect pest population is about 1500 seconds or less—that is, a time of between 0 and about 1500 seconds-preferably a time of about 1200 seconds or less, preferably a time of about 840 seconds or less, and more preferably a time of about 720 seconds or less. The time-to-KD of 90% of a winged insect pest population may also be less than about 540 seconds or less or 420 seconds, preferably about 300 seconds or less, and even a time of about 240 seconds or less or 120 seconds or less. In some embodiments, 100% of a winged insect pest population may be knocked-down in less than about 1500, 1200, 840 or 720 seconds, preferably less than 540 seconds or 420 seconds, preferably about 300 seconds or less, and even a time of about 240 seconds or less or 120 seconds or less. These time-to-KD may often be achieved using the preferred amounts described above.

In certain preferred embodiments, at least about 50% of a winged insect pest population is killed in less than about 48 hours—that is, a time of between 0 and about 48 hours—preferably a time of about 40 hours or less, and more preferably a time of about 32 hours or less or 24 hours or less. In some embodiments, at least about 70% or greater of a winged insect pest population is killed in less than about 48 hours, preferably a time of about 40 hours or less, and more preferably a time of about 32 hours or less or 24 hours or less. In some embodiments, 100% of a winged insect pest population is killed in less than about 48 hours, preferably a time of about 40 hours or less, and more preferably a time of about 32 hours or less or 24 hours or less. These mortality rates may often be achieved using the preferred amounts described above.

In certain preferred embodiments, at least about 80% of a winged insect pest population is moribund or killed in less than about 48 hours—that is, a time of between 0 and about 48 hours-preferably a time of about 40 hours or less, and more preferably a time of about 32 hours or less or 24 hours or less. In some embodiments, at least about 85% or 90% of a winged insect pest population is moribund or killed in less than about 48 hours, preferably a time of about 40 hours or less, and more preferably a time of about 32 hours or less or 24 hours or less. In some embodiments, 100% of a winged insect pest population is moribund or killed in less than about 48 hours, preferably a time of about 40 hours or less, and more preferably a time of about 32 hours or less or 24 hours or less. These moribund and mortality rates may often be achieved using the preferred amounts described above.

In certain preferred embodiments, at least about 80% of a winged insect pest population which, as a result of exposure to the pesticidal combinations disclosed herein, is KD or moribund, later dies. Preferably, at least about 85%, 90% or 95% of a KD or moribund insect population later dies, and preferably 100% of a KD or moribund insect population later dies. In other words, the rate of conversion of KD and/or moribund flying insects to dead flying insects is at least about 80%, 85%, 90% or 95%, or even 100%. It is an advantage of the present invention that low rates of recovery of flying insects from KD and moribund states is provided, or put another way, that KD and moribund states are converted to death at a high rate. This is often not achievable with pyrethrins or pyrethroids alone which may allow a higher proportion of a pest population to recover from KD and moribund states.

As used herein, the term “winged insect” refers to an insect which at any stage of its lifecycle includes wings. Preferably, the winged insect is also capable of flying, in which case the winged insect may be referred to as a flying winged insect.

The winged insect pest when controlled may be in any stage of its life cycle, for example, an egg, larvae, pupa, adult or nymph. In preferred embodiments, the winged insect pest is an adult or larvae, as combinations of the present invention have been found to be particularly effective against adults and larvae.

The winged insects which the combination of the β-diketone compound of formula (I) or the at least one pyrethroid or pyrethrin may be used to control include as follows:
a. from the order of the lepidopterans (Lepidoptera), for example, Adoxophyes orana, Agrotis ipsilon, Agrotis segetum, Alabama argillacea, Anticarsia gemmatalis, Argyresthia conjugella, Autographa gamma, Cacoecia murinana, Capua reticulana, Choristoneura fumiferana, Chilo partellus, Choristoneura occidentalis, Cirphis unipuncta, Cnaphalocrocis medinalis, Crocidolomia binotalis, Cydia pomonella, Dendrolimus pini, Diaphania nitidalis, Diatraea grandiosella, Earias insulana, Elasmopalpus lignosellus, Eupoecilia ambiguella, Feltia subterranea, Grapholitha funebrana, Grapholitha molesta, Heliocoverpa armigera, Heliocoverpa virescens, Heliocoverpa zea, Hellula undalis, Hibernia defoliaria, Hypliantria cunea, Hyponomeuta malinellus, Keiferia lycopersicella, Lambdina fiscellaria, Laphygma exigua, Leucoptera scitella, Lithocolletis blancardella, Lobesia botrana, Loxostege sticticalis, Lymantria dispar, Lymantria monacha, Lyonetia clerkella, Manduca sexta, Malacosoma neustria, Mamestra brassicae, Mocis repanda, Operophthera brumata, Orgyia pseudotsugata, Ostrinia nubilalis, Pandemis heparana, Panolis flamnea, Pectinophora gossypiella, Phthorimaea operculella, Phyllocnistis citrella, Pieris brassicae, Plathypena scabra, Platynota stultana, Plutella xylostella, Prays citri, Prays oleae, Prodenia sunia, Prodenia ornithogalli, Pseudoplusia includens, Rhyacionia frustrana, Scrobipalpula absoluta, Sesamia inferens, Sparganothis pilleriana, Spodoptera frugiperda, Spodoptera littoralis, Spodoptera litura, Syllepta derogata, Synanthedon myopaeforinis, Thaumatopoea pityocampa, Tortrix viridana, Trichoplusia ni, Tryporyza incertulas and Zeiraphera canadensis, also Galleria mellonella, Sitotroga cerealella, Ephestia cautella and Tineola bisselliella;
b. from the order of the beetles (Coleoptera), for example, Anthonomus grandis, Anthonomus pomorum, Apion vorax, Atomaria linearis, Blastophagus piniperda, Cassida nebulosa, Cerotoma trifurcata, Ceuthorhynchus assimilis, Ceuthorhynchus napi, Chaetocnema tibialis, Conoderus vespertinus, Crioceris asparagi, Cryptolestes ferrugineus. Dendroctonus rufipennis, Diabrotica longicornis, Diabrotica punctata, Diabrotica virgifera, Epilachna varivestis, Epitrix hirtipennis, Eutinobothrus brasiliensis, Hylobius abietis, Hypera brunneipennis, Hypera postica, Ips typographus, Lema bilineata, Lema melanopus, Leptinotarsa decemlineata, Limonius californicus, Lissorhoptrus oryzophilus, Melanotus communis, Meligethes aeneus, Melolontha hippocastani, Melolontha melolontha, Oulema oryzae, Otiorhynchus sulcatus, Otiorhynchus ovatus, Phaedon cochleariae, Phyllopertha horticola, Phyllophaga sp., Phyllotreta chrysocephala, Phyllotreta nemorum, Phyllotreta striolata, Popillia japonica, Psylliodes napi, Scolytus intricatus and Sitona lineatus, also Bruchus rufimanus, Bruchus pisorum, Bruchus lentis, Sitophilus granarius, Lasioderma serricorne, Oryzaephilus surinamensis, Rhyzopertha dominica, Sitophilus oryzae, Tribolium castaneum, Trogoderma granarium and Zabrotes subfasciatus;
c. from the order of the dipterans (Diptera), for example, Anastrepha ludens, Ceratitis capitata, Contarinia sorghicola, Dacus cucurbitae, Dacus oleae, Dasineura brassicae, Delia coarctata, Delia radicum, Hydrellia griseola, Hyleniyia platura, Liriomyza sativae, Liriomyza trifolii, Mayetiola destructor, Orseolia oryzae, Oscinella frit, Pegomya hyoscyami, Phorbia antiqua, Phorbia brassicae, Phorbia coarctata, Rhagoletis cerasi and Rhagoletis pomonella, also Aedes aegypti, Aedes vexans, Aedes albopictus, Anopheles maculipennis, Chrysomya bezziana, Cochliomyia hominivorax, Chrysomya macellaria, Cordylobia anthropophaga, Culex pipiens, Culex quinquefasciatus, Fannia canicularis, Gasterophilus intestinalis, Glossina morsitans, Haernatobia irritans, Haplodiplosis equestris, Hypoderma lineata, Lucilia cuprina, Lucilia sericata, Musca domestica, Muscina stabulans, Oestrus ovis, Tabanus bovinus and Simulium damnosum;
d. from the order of the thrips (Thysanoptera), for example, Frankliniella fusca, Frankliniella occidentalis, Frankliniella tritici, Haplothrips tritici, Heliothrips haemorrhoidalis, Scirtothrips citri, Thrips oryzae, Thrips palmi and Thrips tabaci;
e. from the order of the hymenopterans (Hymenoptera), for example, Athalia rosae, Atta cephalotes, Atta sexdens, Atta texana, Hoplocampa minuta, Hoplocampa testudinea, Iridomyrmex humilis, Iridomyrmex purpureus, Monomorium pharaonis, Solenopsis geminata, Solenopsis invicta, Solenopsis richteri and Technomyrmex albipes;
f. from the order of the hemipterans (Hemiptera), for example, Aphis, Bemisia, Phorodon, Aeneolamia, Empoasca, Perkinsiella, Pyrilla, Aonidiella, Coccus, Pseudococcus, Helopeltis, Lygus, Dysdercus, Oxycarenus, Nezara, Aleyrodes, Triatoma, Psylla, Myzus, Megoura, Phylloxera, Adelges, Nilaparvata, Nephotettix or Cimex spp.;
g. from the order of the heteropterans (Heteroptera), for example, Acrosternum hilare, Blissus leucopterus, Cyrtopeltis notatus, Dysdercus cingulatus, Dysdercus intermedius, Eurygaster integriceps, Euschistus ictericus, Leptoglossus phyllopus, Lygus hesperus, Lygus lineolaris, Lygus pratensis, Mormidea pictiventris, Nezara viridula, Piesma quadrata, Solubea insularis and Thyanta perditor;
h. from the order of the homopterarts (Homoptera), for example, Acyrthosiphon onobrychis, Acyrthosiphon pisum, Adelges laricis, Aonidiella aurantii, Aphidula nasturtii, Aphis fabae, Aphis gossypii, Aphis pomi, Bemisia tabaci, Brachycaudus cardui, Dalbulus maidis, Dreyfusia nordmannianae, Dysaphis radicola, Empoasca fabae, Eriosorna lanigerum, Laodelphax striatella, Macrosiphun euphorbiae, Macrosiphon rosae, Megoura viciae, Metopolophium dirhodum, Myzus persicae, Nephotettix cincticeps, Nilaparvata lugens, Perkinsiella saccharicida, Phorodon humuli, Cacopsylla mali, Psylla pyri, Cacopsylla pyricola, Rhopalosiphum maidis, Schizaphis graminum, Sitobion avenae, Sogatella furcifera, Toxoptera citricida, Trialeurodes abutilonea, Trialeurodes vaporariorum and Viteus vitifolaei;
i. from the order of the termites (Isoptera), for example, Kalotermes flavicollis, Coptotermes spp, Leucotermes flavipes, Macrotermes subhyalinus, Macrotermes darwiniensis, Mastotermes spp. Microtermes spp., Nasutitermes spp such as Nasutitermes walkeri, Odontotermes formosanus, Reticulitermes lucifugus and Termes natalensis;
j. from the order of the Blattoidae, for example Blatella germanica, Periplaneta spp., Supella longipalpa, Blatta orientalis, Shelfordella spp, and Drymaplaneta communis;
k. from the order of the orthopterans (Orthoptera), for example, Gryllotalpa gryllotalpa, Locusta migratoria, Melanoplus bivittatus, Melanoplus femurrubrum, Melanoplus mexicanus, Melanoplus sanguinipes, Melanoplus spretus, Nomadacris septemfasciata, Schistocerca americana, Schistocerca peregrina, Stauronotus maroccanus and Schistocerca gregaria, also Acheta domesticus, Blatta orientalis, Blattella germanica and Periplaneta americana; and
l. from the order of the dermapterans (Dermaptera), for example, Forficula spp.

In preferred embodiments, the winged insect pest is from the order of Diptera. In preferred embodiments, the winged insect pest is a dangerous and/or nuisance winged insect pest, which is generally considered to be a mosquito or fly. In preferred embodiments, the winged insect pest is Musca species such as Musca domestica, Aedes species such as Aedes aegypti, Aedes vexans and Aedes albopictus and Culex species such as Culex pipiens and Culex quinquefasciatus. The combinations of the present inventions are particularly effective against these winged insect pests.

In certain embodiments, the winged insect pest is pesticide-resistant.

As used herein, the term “pesticide-resistant” is meant that the winged insect pest has developed resistance to one or more pesticides that has previously been used to control it. The pesticide-resistant winged insect pest may be present in a population of pests. In preferred embodiments, the winged insect is resistant to one or more pyrethroids or pyrethrins. More preferably, the winged insect is permethrin-resistant and/or deltamethrin-resistant, meaning that the winged insect pest has developed resistance to permethrin and/or deltamethrin, and more preferably is permethrin-resistant. For example, the known KS17 strain of the winged insect pest house fly species Musca domestica is known to demonstrate essentially complete resistance to permethrin. Similarly, the known Puerto Rico strain of the winged insect pest mosquito species Aedes aegypti is known to demonstrate resistance to permethrin.

In certain embodiments, the winged insect pest is pesticide-susceptible.

As used herein, the term “pesticide-susceptible” is meant as opposed to pesticide resistant, in that the winged insect pest has not developed resistance to one or more pesticides that has previously been used to control it. The pesticide-susceptible winged insect pest may be present in a population of pests.

The use of the β-diketone compound of formula (I) in combination with one or more pyrethrins or pyrethroids is advantageous. Without wishing to be limited by theory, it is believed that the primary mode of action of pyrethrins and pyrethroids is to act as sodium channel activators to prevent the closure of sodium channels leading to insect paralysis and at times death. On the other hand, the primary mode of action of β-diketone compounds of formula (I) is different, believed to be by acting as potassium channel activators to prevent the closure of potassium channels, often leading to insect incapacitation and specifically knockdown, usually within the space of a few minutes, followed by death. It is further believed that the mode of action of β-diketone compounds of formula (I) arises from the core cyclohexene β-dione motif of the structural formula which defines a compound of formula (I) as described herein. It is postulated that this core motif provides the scaffold for affinity binding with insect potassium ion channels. It is further thought that potassium ion channels play a particularly important role in the development and function of insect wings (see for example George, L. F et al., G3, 2019, 9 (4), 999-1008), and it is postulated that there is a prevalence of potassium ion channels in winged insects, including through the developmental stages of the insect lifecycle. Accordingly, β-diketone compounds of formula (I) are particularly effective in the control of winged insects in combination with a second pesticide selected from a pyrethrin or a pyrethroid. The complementary action of the β-diketone compound of formula (I) in combination with one or more pyrethrins of pyrethroids against winged insect pests thus allows for the reduced use of pyrethrins or pyrethroids and β-diketone compounds of formula (I) in sub-effective and even sub-additive amounts, including against pesticide resistant winged insect pests, while achieving effective control of winged insect pests.

### Compositions of the Invention

The β-diketone compounds of formula (I) and the one or more pyrethrins or pyrethroids may be formulated separately for simultaneous or sequential application, or formulated together in a single composition.

It is preferred that the β-diketone compounds of formula (I) and the one or more pyrethrins or pyrethroids are applied together in a single composition, and thus formulated together. The formulation of a single composition is herein described, though the same generally applies to separate compositions for use in simultaneous or sequential application.

As described herein, the composition may be applied by dispersion in air, application to surfaces or application to an animal, for example by, dipping, spraying, pour-on, washing, fogging or misting, drenching, droplet application or other airborne application methods. The composition may thus be formulated in any suitable form such as a spray, aerosol, oil, emulsifiable concentrate, wettable powder, flowable formulation, granulated formulation, powder, dust, solution, suspension, emulsion, controlled release formulation or other, by means of dissolving, separating, suspending, mixing, impregnating, adsorbing, precipitating or other.

The composition may contain one or more additives or excipients as required, for example a carrier, stabilizer, emulsifier, surfactant, propellant, antioxidant, UV-absorber, humectants or other. Natural ingredients are preferred. Suitable additives and excipients are known to those of skill in the art.

Appropriate formulation selection may be made with consideration of the combination, winged insect pest and environment of control, and is determinable by one of skill in the art. In preferred embodiments, the composition is formulated as a liquid spray for use in an atomizer or aerosol for indoor application.

The β-diketone compounds of formula (I) may be present as, and thus the compositions of the present invention may contain, substantially purified synthetic compound, substantially purified isolated compound, or in crude extract. The use of a crude extract is preferred. When used as a crude extract, preferably the β-diketone compound is present in the crude extract in a high proportion as described herein. A crude extract may be a phytochemical extract as described herein, in which case the compositions of the present invention may contain at least one additional phytochemical that has been extracted from the plant along with the β-diketone compound of formula (I). An additional phytochemical that is other than a β-diketone compound of formula (I), a pyrethroid and a pyrethrin may also be added in compositions of the present invention, for example if other than a plant extract is used as a source of compound of formula (I) and an additional phytochemical is not already present.

The composition may be formulated with a concentration of each of the β-diketone compound of formula (I) and one or more pyrethrins or pyrethroids appropriate for the method of application and equating to winged insect pest exposure to sub-effective amounts of each. Generally speaking, the composition may be formulated as a concentrate for dilution before application. This may amount to, in certain embodiments, compositions comprising in the range of 10 to 50,000 ppm, 100 to 10,000 ppm, 100 to 5000 ppm, or 300 to 5000 ppm, 500 to 5000 ppm, or 800 ppm to 2,500 ppm or 900 ppm to 2,000 ppm, of one or both of the β-diketone compound of formula (I) and one or more pyrethrins or pyrethroids. In other embodiments, the composition may comprise in the range of 100 to 1000 ppm, 200 to 800 ppm, 300 to 600 ppm, or 600 to 5000 ppm, 1000 to 2500 ppm, or 20 to 100 ppm, 25 to 80 ppm, or 20 ppm to 100 ppm or 50 ppm to 100 ppm, of one or both of the β-diketone compound of formula (I) and one or more pyrethrins or pyrethroids.

Application rates of the composition in an environment may be adjusted as required depending on the concentration of the β-diketone compound of formula (I) and one or more pyrethrins or pyrethroids, for exposure of the winged insect pests to sub-effective amounts of each. Generally speaking, application rates to an agricultural environment may be in an amount of the combination within the range of about 0.01 to 200 kg/ha, or 0.1 to 150 kg/ha or anywhere from 1 to 100 kg/ha, for example in a broadcast application. In certain preferred embodiments, the amount of the combination may be in an amount within the range of about 50 to 200 kg/ha, or 75 to 150 kg/ha or 90 to 130 kg/ha, or an amount of about 95 kg/ha or 130 kg/ha, for example within the range of about 90 kg/ha to 100 kg/ha or about 125 to 135 kg/ha. Application rates in a household or industrial environment may be in an amount of the combination within the range of 1 ng/m³ to 1 g/m³, or 1 μg/m³ to 500 mg/m³ or anywhere from 1 mg/m³ to 100 mg/m³, for example in an airborne application.

Together, the β-diketone compounds of formula (I) and one or more pyrethrins or pyrethroids may comprise anywhere from about 0.00005% to about 90% by weight of a single composition.

As described herein, in preferred embodiments, the amount of the β-diketone compound of formula (I) used in the combination is greater than the amount of the at least one pyrethrin or pyrethroid used in the combination, and the same applies to compositions. Depending on the particular winged insect pest, its susceptibility to the combination, the type of control desired and the environment to which the combination is to be applied, the amount of β-diketone compound of formula (I) and the at least one pyrethrin or pyrethroid in the composition may be determined as an amount per insect based on a given application rate, as herein described.

The combination of a β-diketone compounds of formula (I) and the one or more pyrethrins or pyrethroids may be combined with synergists such as piperonyl butoxide (PBO).

One or more other insecticides may also be included, for example an acetylcholinesterase (AChE) inhibitor, GABA-gated chloride channel antagonist, nicotinergic acetylcholine receptor agonist, allosteric acetylcholine receptor modulator, chloride channel actuator, juvenile hormone mimic, homopteran feeding blocker, mitochondrial ATP synthase inhibitor, nicotinic acetylcholine receptor channel blocker, inhibitor of chitin biosynthesis, moulting disruptor, ecdysone receptor agonist or disruptor, octopamine receptor agonist, mitochondrial complex I electron transport inhibitor, acetyl CoA carboxylase inhibitor, voltage-dependent sodium channel blocker and a mitochondrial complex IV electron inhibitor. Insecticides in these categories are known to those of skill in the art and may be obtained commercially.

### Kits

Kits are also contemplated which comprise a β-diketone compound of formula (I) as defined herein, and at least pyrethroid or pyrethrin, together with instructions to expose winged insect pests to a combination thereof using one or both in a sub-effective amount.

The β-diketone compound of formula (I) and at least pyrethroid or pyrethrin may be formulated together or separately as herein described.

The instructions may further contain application rates suitable for specific winged insect pests or environments, preferably concordant with the preferred embodiments as herein described.

The kit may further comprise dispensing apparatus.

As used herein, the terms “a” and “an” are used herein to refer to one or to more than one (i.e. to at least one) of the grammatical object of the article. By way of example, “an element” means one element or more than one element.

Except where the context requires otherwise due to express language or necessary implication, as used herein the term “comprise” or variations such as “comprises” or “comprising” is used in an inclusive sense, i.e. to specify the presence of the stated features but not to preclude the presence or addition of further features in various embodiments of the invention.

It is to be understood that, if any prior art publication is referred to herein, such reference does not constitute an admission that the publication forms a part of the common general knowledge in the art in Australia, or in any other country.

In order that the invention may be readily understood and put into practical effect, particular preferred embodiments will now be described by way of the following non-limiting examples.

### EXAMPLES

A representative procedure for the synthesis of β-dione compounds of formula (I) is as follows: 3-methoxy-2,4,4-trimethylcyclohex-2-en-1,5-dione (1 mole eq) is dissolved in anhydrous diethylether and hexamethylphosphoramide (solvent ratio, 20:1 respectively) under an atmosphere of nitrogen. The mixture is cooled to 0° C. and lithium hydride (1.1 mole eq) (60% in mineral oil) is added in portions. The mixture is stirred for a further 10 mins before the addition of benzoyl cyanide [representing R—CO—CN] (1.1 mole eq). The mixture is allowed to warm to room temperature over 12 h at which time the reaction is quenched with water and partitioned. The ether layer is dried (Na₂SO₄) and evaporated affording crude 1-benzoyl-3-methoxy-2,4,4-trimethylcyclohex-2-en-1,5-dione which is purified by SiO₂ column chromatography (hexane/ethyl acetate, gradient).

An alternative representative procedure for the synthesis of β-dione compounds of formula (I) is as follows: 3-methoxy-2,4,4-trimethylcyclohex-2-en-1,5-dione (1 mole eq) and benzoyl cyanide are dissolved in anhydrous dichloromethane and cooled to 0° C. under an atmosphere of nitrogen. To the cooled solution is added anhydrous finely powdered zinc chloride (1.1 mole eq.) followed by slow addition of triethylamine (1.2 mole eq). The reaction mixture is stirred at room temperature for 5-6 hours and then poured into 2 M hydrochloric acid. The mixture is partitioned and the dichloromethane layer is washed with 5% sodium carbonate. The aqueous carbonate phase is then acidified with hydrochloric acid and extracted with methylene chloride and dried (Na₂SO₄). The solvent is removed and the residue subjected to SiO₂ column chromatography (hexane/ethyl acetate) affording 1-benzoyl-3-methoxy-2,4,4-trimethylcyclohex-2-en-1,5-dione.

Metal salts can be prepared by the reaction of the prepared compounds with corresponding metal hydroxides suspended in methanol or ethanol. Trialkylammonium salts can be prepared by the reaction of the prepared compounds with trialkylamines in a chlorinated solvent such as dichloromethane. Tetraalkylammonium salts can be prepared by adding a halogenated tetraalkylammonium salt to a metal salt in dichloromethane.

### Example 1

Topical Dose-Mortality Assays for Efficacy of Tasmanone Against Aedes aegypti

### Qcide Larval Dose-Mortality Assays

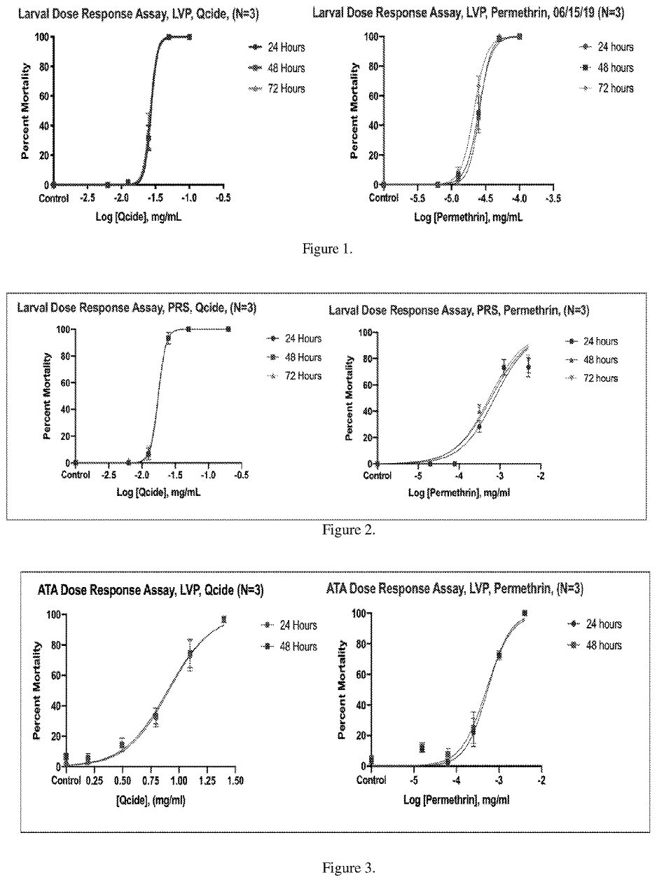

Table 1 presents the results of the toxicity of Qcide formulation (540 EW, 540 g/L E. cloeziana oil, “Qcide” containing a minimum of 75 wt % tasmanone) to Aedes aegypti Permethrin (SP)-susceptible Liverpool (LVP) and SP-resistant Puerto Rico (PRS) strain L3 larvae in larval dose response assays. Results represent n=3 biological replicates. Lethal concentration (LC₅₀) of Qcide at 24, 48 and 72 hours post topical exposure is shown in comparison to the technical grade synthetic pyrethroid, Permethrin (SP), and also the β-triketone flavesone (comparable data integrated from a previous study). See FIGS. 1 and 2.

TABLE 1
Toxicity of Qcide 540EW formulation to Aedes aegypti LVP and
PRS strain L3 larvae in larval dose response assays.

| | Test | Positive | Positive Control |
|---|---|---|---|
| Time Post | Formulation | Control | Permethrin |
| Exposure | Qcide | Flavesone | (SP) |
| | Lethal Concentration (LC₅₀) LVP Strain (SP-susceptible) | | |
| 24 hours | 27.2 μg/mL | 40.9 μg/mL | 25.9 ng/mL |
| 48 hours | 27.2 μg/mL | 40.5 μg/mL | 25.2 ng/mL |
| 72 hours | 26.7 μg/mL | 39.7 μg/mL | 21.4 ng/mL |
| | Lethal Concentration (LC₅₀) PRS Strain (SP-resistant) | | |
| 24 hours | 17.7 μg/mL | 38.7 μg/mL | 0.7 μg/mL |
| 48 hours | 17.7 μg/mL | 37.1 μg/mL | 0.6 μg/mL |
| 72 hours | 17.4 μg/mL | 37.1 μg/mL | 0.6 μg/mL |

The dose-mortality assays revealed toxicity of Qcide to SP-susceptible Aedes aegypti LVP and PRS strain larvae at 24, 48 and 72 hours.

To LVP strain, Qcide exhibited toxicity in the μg range (LC₅₀ 27 μg/mL at 24 hours) as compared to the SP positive control which was toxic in the ng range (LC₅₀ 26 ng/ml at 24 hours), at all time points. By comparison with flavesone as a positive control using comparable data from a previous study, Qcide exhibits greater toxicity than flavesone (LC₅₀ 41 μg/mL at 24 hours) to LVP strain in the μg range, at all time points.

To PRS strain, Qcide exhibited toxicity in the μg range (LC₅₀ 18 μg/mL at 24 hours) as compared to SP positive control which was toxic in the ng range (LC₅₀ 0.7 μg/mL at 24 hours), at all time points. PRS strain larvae exhibited approx. 25-fold greater resistance to SP as compared to LVP strain, under assay conditions. By comparison with flavesone as a positive control using comparable data from a previous study, Qcide exhibits greater toxicity than flavesone (LC₅₀ 39 μg/mL at 24 hours) to PRS strain in the μg range, at all time points.

Dose-mortality data support larvicidal activity of Qcide against SP-resistant mosquitoes, and larvicidal activity of flavesone against SP-resistant mosquitoes though to a lesser extent. This supports a mode of action of Qcide (tasmanone) that is distinct from SP, postulated to be the same as the confirmed mode of action of flavesone, being a potassium channel activator.

### Qcide Adult Dose-Mortality Assays

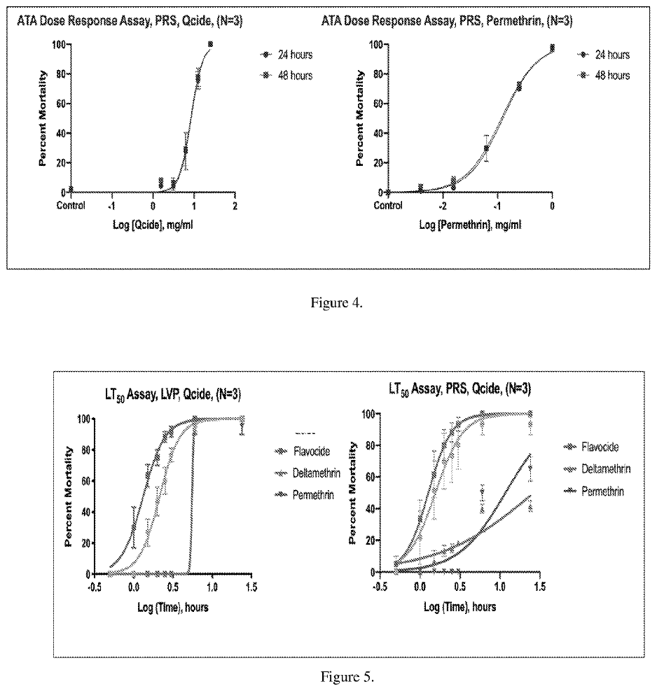

Table 2 presents the results of the toxicity of 540 EW Qcide formulation to Aedes aegypti LVP and PRS strain 3-5 day old adults in dose response assays. Results represent n=3 biological replicates. Lethal concentration (LC₅₀) of Qcide at 24 and 48 hours post exposure is shown in comparison to SP. See FIGS. 3 and 4.

TABLE 2
Toxicity of Qcide 540EW formulation to Aedes aegypti LVP and
PRS strain 3-5 dayold adults in dose response assays.

| | Test | Positive Control |
|---|---|---|
| Time Post | Formulation | Permethrin |
| Exposure | Qcide | (SP) |
| | Lethal Dose (LC₅₀) LVP Strain (SP-susceptible) | |
| 24 hours | 8.1 mg/mL | 542.9 ng/mL |
| 48 hours | 7.9 mg/mL | 504.6 ng/mL |
| | Lethal Dose (LC₅₀⁾ PRS Strain (SP-resistant) | |
| 24 hours | 8.5 mg/mL | 0.13 mg/mL |
| 48 hours | 8.3 mg/mL | 0.12 mg/mL |

The dose-mortality assays revealed toxicity of Qcide to SP-susceptible Aedes aegypti LVP and PRS strain adults at 24 and 48 hours.

To LVP strain, Qcide exhibited toxicity in the mg range (LC₅₀ 8.1 mg/mL at 24 hours) as compared to the SP positive control which was toxic in the ng range (LD₅₀ 543 ng/ml at 24 hours), at both points.

To PRS strain, Qcide exhibited toxicity in the mg range (LC₅₀ 8.5 mg/mL at 24 hours) as compared to SP positive control which was toxic in the μg range (LC₅₀ 130 μg/mL at 24 hours), at both time points. PRS strain adults exhibited approximately 240-fold greater resistance to SP as compared to LVP, under assay conditions.

Dose-mortality data support adulticidal activity of Qcide against SP-resistant mosquitoes and a mode of action distinct from SP.

### Qcide Larval Mortality-Time Assays

Table 3 presents the results of the toxicity of 540 EW Qcide formulation to Aedes aegypti LVP and PRS strain L3 larvae in mortality-time assays. Results represent n=3 biological replicates. Lethal time (LT₅₀) of post topical exposure to a Lethal Concentration (LC₉₀) dose is shown in comparison to SP and the technical grade synthetic pyrethroid, Deltamethrin. See FIG. 5.

TABLE 3
Toxicity of Qcide 540EW formulation to Aedes aegypti LVP
and PRS strain L3 larvae in larval mortality-time assays.

| | Test | Positive Control | Positive Control |
|---|---|---|---|
| Dose | Formulation | Deltamethrin | Permethrin |
| Exposure | Qcide | (SP) | (SP) |
| | Lethal Time (LT₅₀) LVP Strain (SP-susceptible) | | |
| LC₅₀ LVP | 2.1 Hours | 5.5 Hours | 5.6 Hours |
| | Lethal Time (LT₅₀) PRS Strain (SP-resistant) | | |
| LC₅₀ PRS | 1.6 Hours | 26.5 Hours | 11.7 Hours |

The time-mortality assays revealed rapid toxicity of Qcide to SP-susceptible Aedes aegypti LVP and PRS strain larvae.

To LVP strain, activity of Qcide was faster (LT₅₀ 2.1 hours at LC₉₀ dose) as compared to the SP positive controls (Permethrin LT₅₀ 5.5 hours at LC₉₀ dose and Deltamethrin (LT₅₀ 5.6 hours at LC₉₀ dose).

To PRS strain, activity of Qcide was faster (LT₅₀ 1.6 hours at LC₉₀ dose) as compared to the SP positive controls (Permethrin LT₅₀ 26.5 hours at LC₉₀ dose and Deltamethrin (LT₅₀ 11.7 hours at LC₉₀ dose).

Time-mortality data support larvicidal activity of Qcide, against SP-resistant mosquitoes and mode of action distinct from SP.

### Qcide Combinations Larval Dose-Mortality Assays

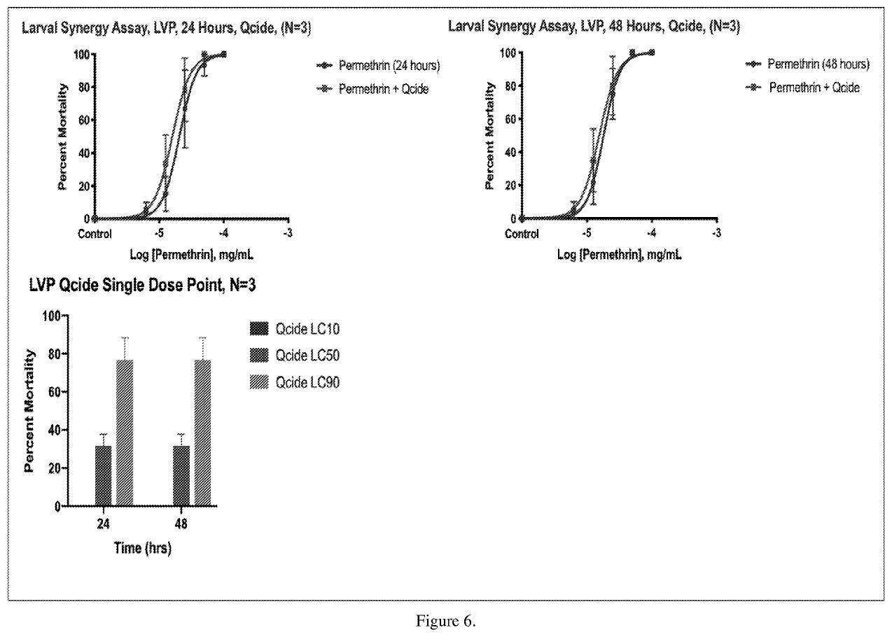

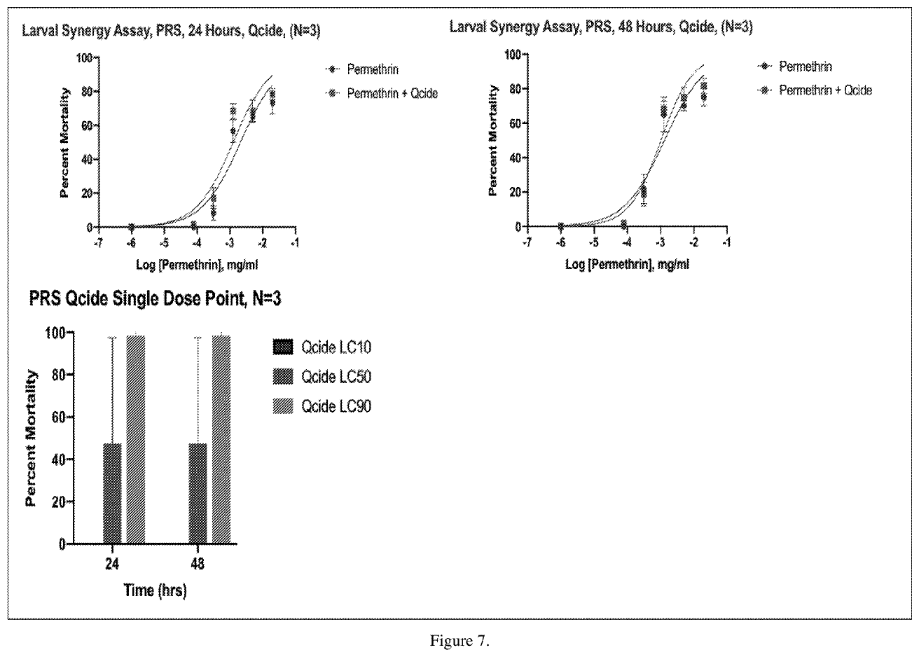

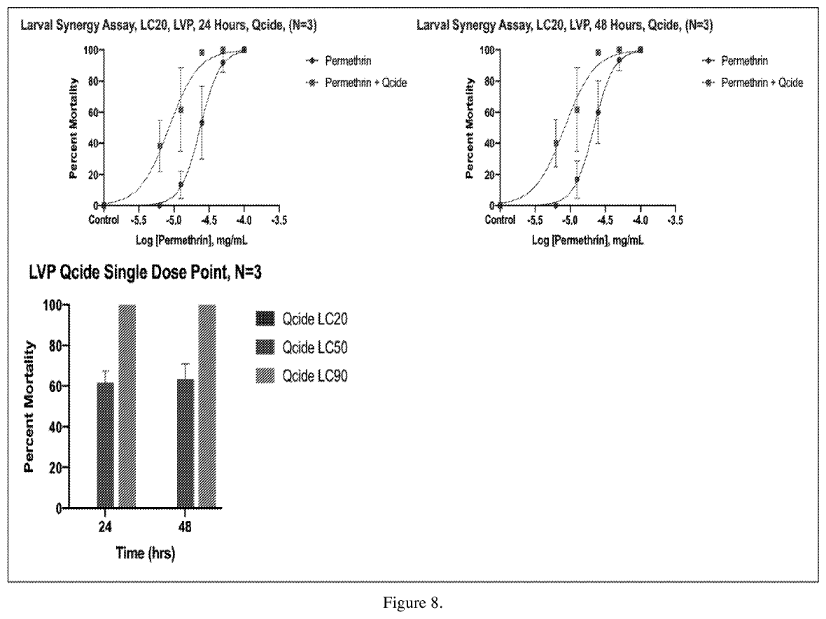

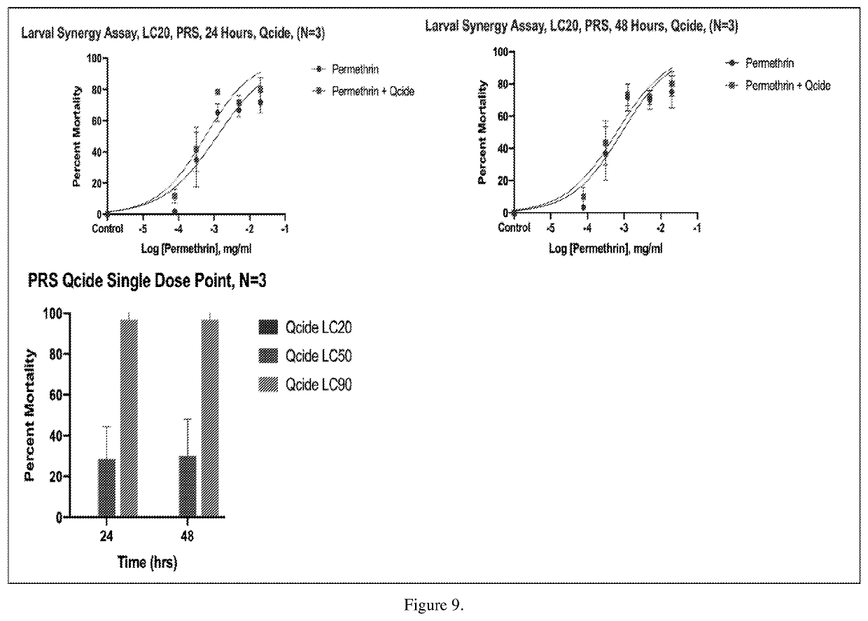

Table 4 presents the results of the toxicity of SP following co-administration of 500 EW Qcide formulation (LC₁₀ dose) to Aedes aegypti LVP and PRS strain L3 larvae in dose-mortality assays. Results represent n=3 biological replicates. Toxicity is reported as Lethal Concentration (LC₅₀) value with 95% Confidence Interval. The Synergistic Ratio (SR) and P-value are shown. See FIGS. 6 and 7. Mosquito mortality is shown for A and B: LVP at 24 and 48 hours. The lower panel shows Qcide positive control at LC₁₀, LC₅₀ and LC₉₀ dose. See FIGS. 8 and 9. Mosquito mortality is shown for A and B: PRS at 24 and 48 hours. The lower panel shows Qcide positive control at LC₁₀, LC₅₀ and LC₉₀ dose.

TABLE 4
Toxicity of SP following co-administration with Qcide 540EW
formulation (LC₁₀ dose) to Aedes aegypti LVP and PRS strain
L3 larvae in larval dose-mortality assays.

| | Permethrin | | | | |
|---|---|---|---|---|---|
| | (ng/mL) | | Permethrin (ng/mL) + Qcide LC₁₀ | | |
| | LC₅₀ | | LC₅₀ | | |
| Strain | (95% CL) | n^{a} | (95% CL) | SR^{b} | P-value |
| LVP (24 hours) | 20.5 | 360 | 16.0 | 1.3 | 0.0013** |
| LVP (48 hours) | 18.1 | 360 | 15.5 | 1.2 | 0.1164 |
| PRS (24 hours) | 2100 | 360 | 1259 | 1.7 | 0.0916 |
| PRS (48 hours) | 1304 | 360 | 1024 | 1.3 | 0.4335 |

n^{a} total number larvae per n = 3 biological replicates
SR, Synergistic Ratio;
LC₅₀ Permethrin/LC₅₀ Permethin + Flavocide P-value;
calculated via t-test and SR values,
**p < 0.01 ns, not significant

Table 5 presents the results of the toxicity of SP following co-administration of 540 EW Qcide formulation (LC₂₀ dose) to Aedes aegypti LVP and PRS strain L3 larvae in dose-mortality assays. Results represent n=3 biological replicates. Toxicity is reported as Lethal Concentration (LC₅₀) value with 95% Confidence Interval. The Synergistic Ratio (SR) and P-value are shown.

TABLE 5
Toxicity of SP following co-administration with Qcide 540EW
formulation (LC₂₀ dose) to Aedes aegypti LVP and PRS strain
L3 larvae in larval dose-mortality assays.

| | Permethrin | | | | |
|---|---|---|---|---|---|
| | (ng/mL) | | Permethrin (ng/mL) + Qcide LC₁₀ | | |
| | LC₅₀ | | LC₅₀ | | |
| Strain | (95% CL) | n^{a} | (95% CL) | SR^{b} | P-value |
| LVP (24 hours) | 23.7 | 360 | 8.5 | 2.8 | 0.0002** |
| LVP (48 hours) | 21.7 | 360 | 8.3 | 2.6 | 0.2702 |
| PRS (24 hours) | 1213 | 360 | 567 | 2.1 | 0.0611 |
| PRS (48 hours) | 870 | 360 | 626 | 1.4 | 0.2702 |

nª total number larvae per n = 3 biological replicates
SR, Synergistic Ratio;
LC₅₀ Permethrin/LC₅₀ Permethin + Flavocide P-value;
calculated via t-test and SR values,
**p < 0.01 ns, not significant

LC₁₀ and LC₂₀ dose Qcide significantly increased toxicity of Permethrin to Aedes aegypti mosquitoes.

Dose-mortality assays revealed statistically significant synergistic activity of Qcide against Aedes aegypti LVP larvae in combination with the SP positive control at 24 hours (LC₁₀ and LC₂₀ dose Qcide significant at p<0.01). In particular, LC₅₀ SP alone was 20.5 ng/ml and 23.7 ng/mL, in combination with LC₁₀ and LC₂₀ dose of Qcide was 16.0 ng/ml and 8.5 ng/ml, respectably, at 24 hours.

LC₁₀ and LC₂₀ dose Qcide also biologically meaningfully increased toxicity of Permethrin to Aedes aegypti mosquitoes.

Dose-mortality assays revealed biologically meaningful synergistic activity of Qcide against Aedes aegypti PRS larvae in combination with the SP positive control at 24 hours (LC₁₀ and LC₂₀ dose Qcide biologically meaningful at p<0.1). In particular, LC₅₀ SP alone was 2100 ng/ml and 1213 ng/mL, in combination with LC₁₀ and LC₂₀ dose of Qcide was 1259 ng/ml and 567 ng/ml, respectably, at 24 hours.

### Example 2

Topical Dose-Mortality Assays for Efficacy of Tasmanone Against Musca domestica

A study was conducted to test a sublethal dose of both Flavocide and Qcide (technical grade material) as topical synergists when applied coincidentally with LD₅₀ topical doses of either permethrin or pyrethrin insecticides against both insecticide resistant and susceptible strains of house flies. The classic synergist, piperonyl butoxide (PBO) was the synergist to which both Flavocide and Qcide were compared. A Co-toxicity factor was determined for each synergist for 24-hour mortality using the following equation:

$$Co - toxicity Factor = \frac{Observed Mortality - Expected Mortality}{Expected Mortality} \times 100$$

where:
Observed Mortality was the number of flies knocked down or dead in the combined treatments of insecticide and synergist;
Expected Mortality was the summation of knocked down or dead flies in the insecticide only and the synergist only treatments;
a co-toxicity factor value of >20 represents synergism, values −20≤but ≤20 were considered additive mixtures, and <−20 were considered antagonistic mixtures; and
a synergism ratio (SR) was calculated by dividing the percent knockdown or mortality of the insecticide only treatment with the insecticide plus synergist treatment. This number represented the fold change in percent mortality with the synergist.

### Materials and Methods

Two strains of house flies (Musca domestica) were used for this study. The insecticide susceptible strain was reared at the USDA-ARS-CMAVE in Gainesville, FL and referred to as the ‘CAR21’ strain. The resistant strain, known as the ‘KS17’ strain contains numerous resistance mechanisms to both pyrethroids and organophosphates, with exceptionally high resistant to pyrethroids. The KS17 strain was reared in the lab for the duration of this study.

Chemicals used for this study were permethrin (purity 99.5%, 23.8% cis isomer, 75.8% trans isomer, Chem Service, Lot: 6343500), pyrethrum extract (>50% summed pyrethrins I and II, Lot BCCB9487), piperonyl butoxide (purity 90%, Acros Organics, Lot: A0378711), Flavocide technical (flavesone, Batch FC1250017001BL, containing a minimum of 95 wt % flavesone) and Qcide (tasmanone, Batch BGTQ1812, containing 80.7 wt % tasmanone). All insecticides and synergists were diluted in pesticide grade acetone.

Twenty 3-5 day old female house flies were sorted into each of 12 glass Petri dishes under CO₂ anesthesia. Flies were allowed to recover from the anesthesia before being used in the assays. In the case of the CAR21 strain, the LD₅₀ doses of permethrin and pyrethrins were a final dose of 12 ng/fly of permethrin and 0.3% (v/v) of pyrethrins. For the KS17 strain, a dose of 5000 ng/fly for permethrin was used as this was the upper limit of what could be applied to the flies before the insecticide began recrystallizing on the fly's dorsal notum. This strain is known for having minimal to no mortality at this dose. A dose of 1% (v/v) pyrethrins was used for KS17. For both strains, a maximum sublethal dose was determined for Flavocide (0.3% v/v), Qcide (1.25% v/v), and PBO (10 μg/fly). Doses of AI or synergist were created by making serial dilutions to a total volume of 500 μL in acetone.

Flies were anesthetized using cold (ice) and a 0.5 μL drop of synergist was applied to the dorsal notum of each fly using a Hamilton PB-600 repeating dispenser fitted with a 25 μL gastight syringe. After the application of the synergist, the insecticide was immediately applied as before to the same location as the synergist droplet, thus mixing them. The flies were then moved into a 236.6 mL (8 oz) flint glass jar and secured in place with a mesh screen. Flies were provided a 20% sucrose solution-soaked cotton ball on the mesh screen as a water and carbohydrate source. Flies were placed inside an environmental chamber held at 25° C. and atmospheric relative humidity.

Knockdown was defined as flies that exhibited extreme deficiency in coordinated movement, including ambulation and flight compared to the control flies from that replicate. Otherwise, knocked down flies could regain standing position when on their dorsal side when the jars were gently tapped on a countertop and could conduct normal behaviors such as grooming.

Mortality was assessed at 24 hours and scored as any fly that could not regain a standing position when on its dorsal side or showing a total lack of movement.

These experiments were replicated four times for each strain and unique treatment or control.

Differences between the insecticides and insecticides plus synergists, as well as the comparisons of insecticides with PBO and insecticides with Flavocide or Qcide were analyzed in R version 4.1.1 using a Fisher's exact test. Dead and alive for each treatment were pooled for this analysis. Mansour's co-toxicity index also was used to calculate synergism at 24-hour mortality.

### Results

Table 6 presents the results of the 24-hour mortality assays, co-toxicity factor (Co-Tox) and synergist ratios (SR; percent KD of the synergized insecticide divided by the percent KD of insecticide alone) of Qcide (Q), Flavocide (Fla) and piperonyl butoxide (PBO) synergists paired with permethrin (Per) and pyrethrins (Py) in an insecticide susceptible (CAR21) and insecticide resistant (KS17) strain of house fly. Co-Tox values in bold represent synergism.

TABLE 6
Mortality results of Fla, Q and PBO synergists paired
with Per and Py to CAR21 and KS17 house fly strains.

| Strain | Treatment | Dead | Alive | Total | % Dead | Co-Tox | SR |
|---|---|---|---|---|---|---|---|
| CAR21 | Acetone | 0 | 80 | 80 | 0.0 | | |
| | Py | 42 | 38 | 80 | 52.5 | | |
| | Per | 6 | 74 | 80 | 7.5 | | |
| | PBO | 0 | 80 | 80 | 0.0 | | |
| | Fla | 0 | 80 | 80 | 0.0 | | |
| | Q | 0 | 80 | 80 | 0.0 | | |
| | PyQ | 71 | 9 | 80 | 88.8 | 69.0 | 1.69 |
| | PyFla | 56 | 24 | 80 | 70.0 | 33.3 | 1.33 |
| | PyPBO | 80 | 0 | 80 | 100.0 | 90.5 | 1.90 |
| | PerQ | 24 | 56 | 80 | 30.0 | 300.0 | 4.00 |
| | PerFla | 8 | 72 | 80 | 10.0 | 33.3 | 1.33 |
| | PerPBO | 78 | 2 | 80 | 97.5 | 1200.0 | 13.00 |
| KS17 | Acetone | 2 | 77 | 79 | 2.5 | | |
| | Py | 9 | 70 | 79 | 11.4 | | |
| | Per | 3 | 77 | 80 | 3.8 | | |
| | PBO | 3 | 74 | 77 | 3.9 | | |
| | Q | 3 | 77 | 80 | 3.8 | | |
| | PyQ | 17 | 63 | 80 | 21.3 | 40.3 | 1.87 |
| | PyFla | 27 | 53 | 80 | 33.8 | 139.4 | 2.96 |
| | PyPBO | 78 | 1 | 79 | 98.7 | 545.8 | 8.67 |
| | PerQ | 10 | 70 | 80 | 12.5 | 66.7 | 3.33 |
| | PerFla | 9 | 71 | 80 | 11.3 | 74.3 | 3.00 |
| | PerPBO | 76 | 4 | 80 | 95.0 | 1142.5 | 25.33 |

Qcide was synergistic with permethrin and pyrethrins against insecticide susceptible strain CAR21, more-so than flavesone, and synergistic with permethrin and pyrethrins against insecticide resistant strain KS17.

Qcide is thus demonstrated to have potential as synergists with pyrethrins and permethrin against both susceptible and resistant house flies.

### Example 3

Knockdown and Kill Assays of Tasmanone Against Musca domestica

A study was conducted to determine if knockdown and mortality performance of Pyrethrins (+PBO) against Musca domestica could be improved with the addition of Qcide (containing a minimum of 80 wt % tasmanone). The products supplied for testing are as set out in Table 7.

TABLE 7
Products supplied for dilution and
administration to Musca domestica.

| | Qcide | Pyrethrins | PBO |
|---|---|---|---|
| Product | (g/L) | (g/L) | (g/L) |
| A | 100 | 3.5 | 16 |
| C | — | 3.5 | 16 |
| Qcide 540EW Formulation | 540 | — | — |

The study was performed in a chamber of internal dimensions 70 cm by 70 cm by 70 cm, consisted of an aluminum frame with glass sides and top, laboratory grade stainless steel base, with a hinged front door and a small sliding glass door in the front door to allow for introduction of flies and aerosol spray. The environment temperature was maintained at 22±2° C.

For each treatment the chamber was cleaned using detergent and water. The chamber was then dried completely. Twenty (20) mixed sex 2-5 days old adult house flies of Musca domestica were introduced into the chamber. A Preval spray system was fitted to a solenoid spray system. The nozzle of the Preval spray system was pointed slightly upwards to aim at the middle of the upper half of the back wall of the chamber. Three replicates of each treatment were undertaken.

The Preval Spray system consisted of an aerosol can with a dip tube into a connected glass container. The glass container could be unscrewed from the aerosol can and the candidate insecticide introduced into the glass container and the container re-attached. When the nozzle on the aerosol was depressed the insecticide is sucked up the dip tube and passed out of the nozzle as an aerosol spray. The Preval spray system was placed in an automatic spray device that was set for the required spray time.

Qcide and Product C, both EW formulations, were diluted in water to the dilutions detailed in the Table 8 for the treatments used in the study.

TABLE 8
Treatment administered to Musca domestica.

| | Qcide | Pyrethrins | PBO |
|---|---|---|---|
| Treatment | (g/L) | (g/L) | (g/L) |
| Qcide 540 EW | 100 | — | — |
| Product C | — | 3.5 | 16 |
| Product C 50% | — | 1.75 | 8 |
| Product C 25% | — | 0.875 | 4 |
| Product A | 100 | 3.5 | 16 |
| Product A 50% | 100 | 1.75 | 8 |
| Product A 25% | 100 | 0.875 | 4 |
| Control | — | — | — |

The automatic spraying system was activated to give a spray duration of 2.0 seconds. After spraying the weight of the spray discharge was noted.

Housefly knockdown was noted at various timed intervals up to a maximum period of 1,800 seconds (30 minutes). Houseflies were considered knocked down when they were incapable of coordinated movement i.e. on their back or side.

After 1,800 seconds the flies were collected and placed in a clean plastic holding container with a 10% sucrose pad, to check for recovery. Mortality was observed at 24 hours post treatment. A Housefly was considered dead when there was no obvious movement from any appendage (observed) for a period of 3 seconds.

The control consisted of 20 houseflies handled in the same manner as for the active treatment; no active treatment was present in the chamber. Knockdown and mortality was noted as above for the active treatments.

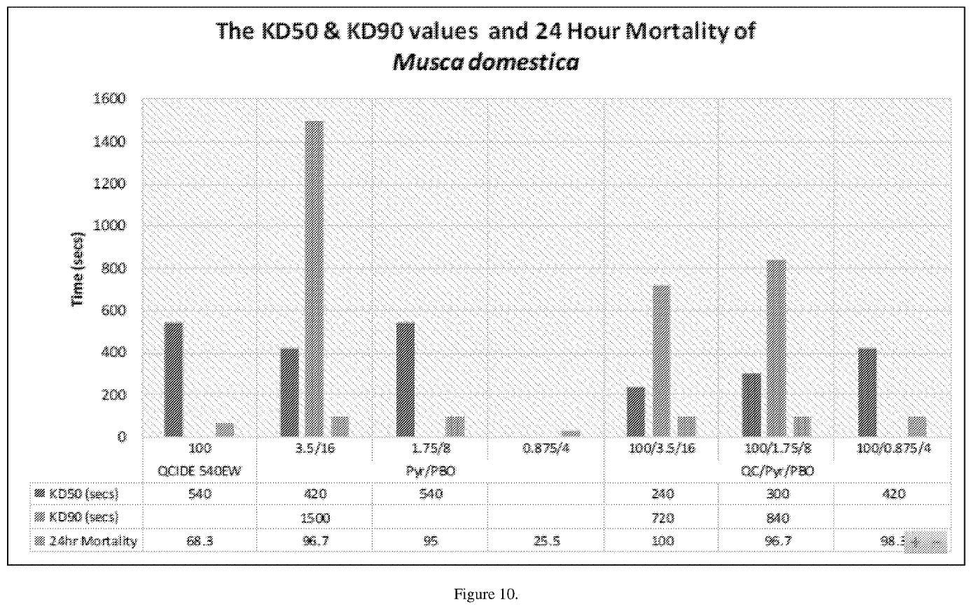

In the results, Qcide at the concentration of 100 g/L took 540 seconds to reach the KD50. KD90 was not reached. 24-h mortality was 68.3%. Product C took 420 seconds to reach KD50 and 1500 seconds to reach KD90. 24-hour mortality was 96.7%. Product C 50% took 540 seconds to reach KD50 and 1500 seconds to reach KD90. 24-hour mortality was 95.0%. For Product C 25%, KD50 and KD90 were not reached. 24-hour mortality was 25.5%. Product A took 240 seconds to reach the KD50 and 720 seconds to reach the KD90. 24-hour mortality was 100%. Product A 50% took 300 seconds to reach the KD50 & 840 seconds to reach the KD90. 24-hour mortality was 96.7%. Product A 25% took 420 seconds to reach the KD50 and 1200 seconds to reach the KD90. 24-hour mortality was 98.3%. FIG. 10 and Table 9 presents the KD50 & KD90 values and the 24-hour mortality results.

TABLE 9
KD50 & KD90 values and the 24 Hour Mortality of Musca domestica.

| | Qcide | Pyrethrins | PBO | KD50 | KD90 | 24-hr |
|---|---|---|---|---|---|---|
| Treatment | (g/L) | (g/L) | (g/L) | (seconds) | (seconds) | mortality |
| Qcide 540 EW | 100 | — | — | 540 | Not reached | 68.3 |
| Product C | — | 3.5 | 16 | 420 | 1500 | 96.7 |
| Product C 50% | — | 1.75 | 8 | 540 | Not reached | 95.0 |
| Product C 25% | — | 0.875 | 4 | Not reached | Not reached | 25.5 |
| Product A | 100 | 3.5 | 16 | 240 | 720 | 100.0 |
| Product A 50% | 100 | 1.75 | 8 | 300 | 840 | 96.7 |
| Product A 25% | 100 | 0.875 | 4 | 420 | 1200 | 98.3 |
| Control | — | — | — | Not reached | Not reached | 3.3 |

*The KD50 and KD values are approximate only if the mean did not equal 50% or 90% at a designated time point.

Product A (i.e. the addition of Qcide to Product C) improved the KD50, KD90 and 24-hour mortality. This was also true of Product A 50% (i.e. the addition of Qcide to Product C 50%). Product A 25% (i.e. the addition of Qcide to Product C 25%) improved KD50 and KD90 to a lesser extent but showed a marked improvement in 24-hour mortality. The results demonstrate the benefit of the addition of Qcide to sub-label rates of Pyrethrins/PBO and are promising in suggesting that Qcide is synergistic with Pyrethrins/PBO.

### Example 4

Efficacy of Tasmanone in Combination with Pyrethrin Against Musca domestica

### Outline

A series of laboratory bioassays were undertaken to investigate the efficacy, in terms of knockdown and mortality, of Qcide formulation (540 EW, 540 g/L E. cloeziana oil, “Qcide” containing ca. 80 wt % tasmanone), when applied in combination with Pyrethrin (Pyrocide 50 formulation containing 50 g/L pyrethrin), against pyrethrins-susceptible adult female houseflies of species M. domestica.

Qcide and pyrethrins were tested in combination and alone. Houseflies were placed into a meshed plastic container and positioned for spray application. The treatment was applied via a potter spray tower. Knockdown and mortality were assessed at 10 seconds, 2, 3, 4, 5, 10, 15, 20, 25 and 30 minutes, and at 1, 24, 48, 72 and 96-hours post spray application.

### Methods

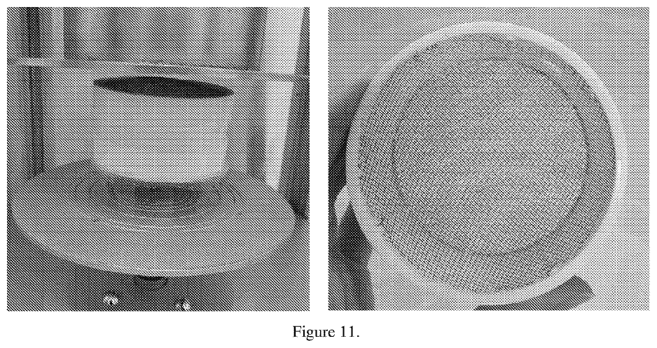

10 adult female houseflies were counted into a holding container which consisted of an 8.5 cm diameter plastic container with mesh at each opening to allow a spray plume to travel through. A plastic stand was used to elevate the holding chamber from the base of the potter tower spray platform. See FIG. 11. The treatments were based on relevant lethal concentration (LC) rates as show in Table 10, as determined by preliminary testing and using Probit analyses using ToxRat Professional version 3.3.

TABLE 10
Lethal concentration values for Qcide
and pyrethrin against M. domestica.

| | Qcide | | | Pyrethrin | | |
|---|---|---|---|---|---|---|
| Toxicity Metric | LC₂₅ | LC₅₀ | LC₇₅ | LC₂₅ | LC₅₀ | LC₇₅ |
| Value (g ai/L) | 81.20 | 113.06 | 157.41 | 8.34 | 12.14 | 17.65 |
| Lower95%-cl | 63.41 | 96.23 | 174.96 | 5.13 | 8.86 | 13.34 |
| Upper95%-cl | 95.50 | 131.43 | 292.91 | 11.05 | 16.54 | 28.43 |

The treatment was applied via a Potter spray tower which was pre-calibrated to deliver a spray volume of 0.1 mL per 100 cm² (100 L per ha). After spray application, the flies were immediately transferred into untreated recovery containers, via the use of CO₂ to make the flies manageable for transfer. The recovery containers consisted of a plastic ½ pint cup with mesh fleece secured to the cup with an elastic band. The flies were provided with a cotton pad soaked in a 10% sucrose solution after transfer. The treatment schedule is provided in Table 11.

TABLE 11
Treatment schedule for Qcide + pyrethrin combination testing against M. domestica.

| No. | Identifier | Rate |
|---|---|---|
| 1 | Water control | N/A |
| 2 | Qcide LC₂₅ | 81.2 g ai/L |
| 3 | Qcide LC₅₀ | 113.06 g ai/L |
| 4 | Qcide LC₇₅ | 157.41 g ai/L |
| 5 | Pyrethrin LC₂₅ | 8.34 g ai/L |
| 6 | Pyrethrin LC₅₀ | 12.14 g ai/L |
| 7 | Qcide LC₂₅ + Pyrethrin LC₂₅ | 81.2 g ai/L Qcide + 8.34 g ai/L Pyrethrin |
| 8 | Qcide LC₂₅ + Pyrethrin LC₅₀ | 81.2 g ai/L Qcide + 12.14 g ai/L Pyrethrin |
| 9 | Qcide LC₅₀ + Pyrethrin LC₂₅ | 113.06 g ai/L Qcide + 8.34 g ai/L Pyrethrin |
| 10 | Qcide LC₅₀ + Pyrethrin LC₅₀ | 113.06 g ai/L Qcide + 12.14 g ai/L Pyrethrin |
| 11 | Qcide LC₇₅ + Pyrethrin LC₂₅ | 157.41 g ai/L Qcide + 8.34 g ai/L Pyrethrin |
| 12 | Qcide LC₇₅ + Pyrethrin LC₅₀ | 157.41 g ai/L Qcide + 12.14 g ai/L Pyrethrin |

Treatments were diluted in deionised water and mixed thoroughly in a vortex prior to spray application. Spray applications were made using the Potter spray tower (Burkard Manufacturing Co. Limited, Hertfordshire, England) pre-calibrated to deliver a scaled spray atomisation equivalent to 100 L/ha. Each test unit was sprayed individually. Five replicates were conducted per treatment.

Knockdown and mortality were assessed at 10 seconds, 2, 3, 4, 5, 10, 15, 20, 25, 30 minutes and at 1, 24, 48, 72 and 96 hours post spray application. Knockdown was taken to be a state in which an insect was rendered incapable of coordinated movement or unable to right itself following exposure to a pesticide product. Moribund was taken to be an insect on its back with only a single appendage twitching. Mortality was taken to be a dead insect, being one that did not move, even when poked or probed.

During the experimental period, temperature ranged between 21.0° C. and 25.6° C. (average 22.1° C.) and relative humidity ranged between 44% and 52% (average 49%). For full details of the environmental conditions see Appendix IV.

### Results

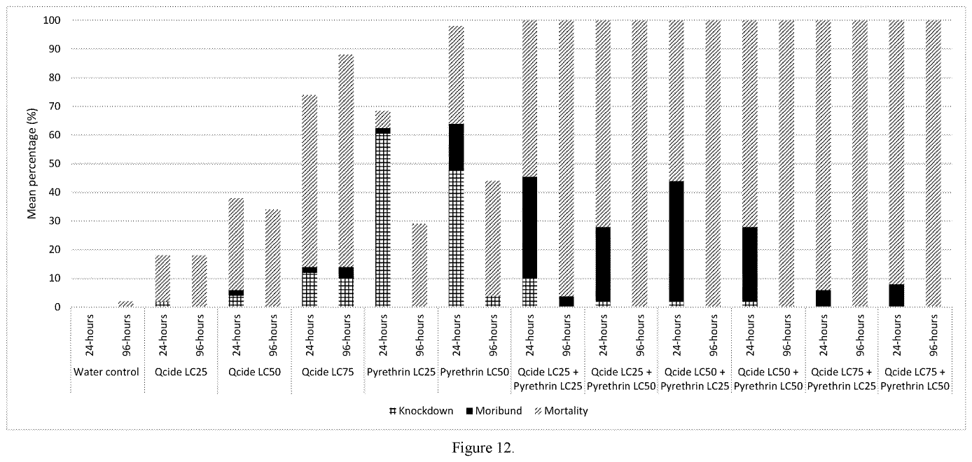

FIG. 12 presents the results of the mean percentage knockdown, moribund and mortality of M. domestica following spray application at 24- and 96-hours. All combination treatments exhibited 100% efficacy in combined knockdown, moribund state and mortality at both 24- and 96-hours post-application, which improved upon each of Qcide and pyrethrin at equivalent application rates alone. All combination treatments also improved mortality at both 24- and 96-hours post-application as compared with each of Qcide and Pyrethrin at equivalent application rates alone.

Table 12 presents the mean percentage knockdown, moribund and mortality of M. domestica following spray application of Qcide and pyrethrin treatments alone over a 96-hour period (means±SE, n=5) (KD=Knockdown, M=Moribund and D=Dead). Table 13 presents the mean percentage knockdown, moribund and mortality of M. domestica following spray application of Qcide and pyrethrin combination treatments over a 96-hour period (means±SE, n=5) (KD=Knockdown, M=Moribund, D=Dead, Q=Qcide, P=pyrethrin).

TABLE 12
Mean percentage KD, M and D of M. domestica for Qcide and pyrethrin treatments alone over a 96-hour period.

| | Water control | | | Q LC25 | | | Q LC50 | | | Q LC₇₅ | | | P LC₂₅ | | | P LC₅₀ | | |
|---|---|---|---|---|---|---|---|---|---|---|---|---|---|---|---|---|---|---|
| Time point | KD | M | D | KD | M | D | KD | M | D | KD | M | D | KD | M | D | KD | M | D |
| 2 min | 0.0 | 0.0 | 0.0 | 0.0 | 0.0 | 0.0 | 0.0 | 0.0 | 0.0 | 0.0 | 0.0 | 0.0 | 100.0 | 0.0 | 0.0 | 100.0 | 0.0 | 0.0 |
| | ±0.0 | ±0.0 | ±0.0 | ±0.0 | ±0.0 | ±0.0 | ±0.0 | ±0.0 | ±0.0 | ±0.0 | ±0.0 | ±0.0 | ±0.0 | ±0.0 | ±0.0 | ±0.0 | ±0.0 | ±0.0 |
| 15 min | 0.0 | 0.0 | 0.0 | 12.0 | 0.0 | 0.0 | 0.0 | 0.0 | 0.0 | 0.0 | 0.0 | 0.0 | 100.0 | 0.0 | 0.0 | 100.0 | 0.0 | 0.0 |
| | ±0.0 | ±0.0 | ±0.0 | ±12.0 | ±0.0 | ±0.0 | ±0.0 | ±0.0 | ±0.0 | ±0.0 | ±0.0 | ±0.0 | ±0.0 | ±0.0 | ±0.0 | ±0.0 | ±0.0 | ±0.0 |
| 30 min | 0.0 | 0.0 | 0.0 | 12.0 | 0.0 | 0.0 | 18.0 | 0.0 | 0.0 | 20.0 | 0.0 | 0.0 | 100.0 | 0.0 | 0.0 | 100.0 | 0.0 | 0.0 |
| | ±0.0 | ±0.0 | ±0.0 | ±12.0 | ±0.0 | ±0.0 | ±3.7 | ±0.0 | ±0.0 | ±5.5 | ±0.0 | ±0.0 | ±0.0 | ±0.0 | ±0.0 | ±0.0 | ±0.0 | ±0.0 |
| 1 hour | 0.0 | 0.0 | 0.0 | 28.0 | 0.0 | 0.0 | 40.0 | 0.0 | 0.0 | 52.0 | 0.0 | 0.0 | 100.0 | 0.0 | 0.0 | 100.0 | 0.0 | 0.0 |
| | ±0.0 | ±0.0 | ±0.0 | ±13.6 | ±0.0 | ±0.0 | ±4.5 | ±0.0 | ±0.0 | ±5.8 | ±0.0 | ±0.0 | ±0.0 | ±0.0 | ±0.0 | ±0.0 | ±0.0 | ±0.0 |
| 24 hours | 0.0 | 0.0 | 0.0 | 2.0 | 0.0 | 16.0 | 4.0 | 2.0 | 32.0 | 12.0 | 2.0 | 60.0 | 60.5 | 2.0 | 5.8 | 48.0 | 16.0 | 34.0 |
| | ±0.0 | ±0.0 | ±0.0 | ±2.0 | ±0.0 | ±6.8 | ±2.4 | ±2.0 | ±5.8 | ±5.8 | ±2.0 | ±5.5 | ±12.4 | ±2.0 | ±2.4 | ±7.3 | ±7.5 | ±4.0 |
| 48 hours | 0.0 | 0.0 | 2.0 | 0.0 | 0.0 | 16.0 | 0.0 | 0.0 | 34.0 | 4.0 | 4.0 | 70.0 | 8.0 | 0.0 | 23.1 | 22.0 | 2.0 | 26.0 |
| | ±0.0 | ±0.0 | ±2.0 | ±0.0 | ±0.0 | ±6.8 | ±0.0 | ±0.0 | ±6.8 | ±2.4 | ±4.0 | ±6.3 | ±3.7 | ±0.0 | ±6.5 | ±5.8 | ±2.0 | ±6.8 |
| 72 hours | 0.0 | 0.0 | 2.0 | 0.0 | 0.0 | 16.0 | 0.0 | 0.0 | 34.0 | 14.0 | 6.0 | 72.0 | 11.5 | 0.0 | 33.1 | 26.0 | 6.0 | 30.0 |
| | ±0.0 | ±0.0 | ±2.0 | ±0.0 | ±0.0 | ±6.8 | ±0.0 | ±0.0 | ±6.8 | ±6.8 | ±4.0 | ±5.8 | ±3.6 | ±0.0 | ±6.8 | ±4.0 | ±2.4 | ±7.1 |
| 96 hours | 0.0 | 0.0 | 2.0 | 0.0 | 0.0 | 18.0 | 0.0 | 0.0 | 34.0 | 10.0 | 4.0 | 74.0 | 0.0 | 0.0 | 29.1 | 4.0 | 0.0 | 40.0 |
| | ±0.0 | ±0.0 | ±2.0 | ±0.0 | ±0.0 | ±5.8 | ±0.0 | ±0.0 | ±6.8 | ±5.5 | ±4.0 | ±6.0 | ±0.0 | ±0.0 | ±6.2 | ±4.0 | ±0.0 | ±8.9 |

TABLE 13
Mean percentage KD, M and D of M. domestica for Qcide and pyrethrin combination treatments over a 96-hour period.

| Time | Q LC₂₅ + P LC₂₅ | | | Q LC₂₅ + P LC₅₀ | | | Q LC₅₀ + P LC₂₅ | | | Q LC₅₀ + P LC₅₀ | | | Q LC7₅ + P LC₂₅ | | | Q LC7₅ + P LC₂₅ | | |
|---|---|---|---|---|---|---|---|---|---|---|---|---|---|---|---|---|---|---|
| point | KD | M | D | KD | M | D | KD | M | D | KD | M | D | KD | M | D | KD | M | D |
| 2 | 100.0 | 0.0 | 0.0 | 100.0 | 0.0 | 0.0 | 100.0 | 0.0 | 0.0 | 100.0 | 0.0 | 0.0 | 100.0 | 0.0 | 0.0 | 100.0 | 0.0 | 0.0 |
| min | ±0.0 | ±0.0 | ±0.0 | ±0.0 | ±0.0 | ±0.0 | ±0.0 | ±0.0 | ±0.0 | ±0.0 | ±0.0 | ±0.0 | ±0.0 | ±0.0 | ±0.0 | ±0.0 | ±0.0 | ±0.0 |
| 15 | 100.0 | 0.0 | 0.0 | 100.0 | 0.0 | 0.0 | 100.0 | 0.0 | 0.0 | 100.0 | 0.0 | 0.0 | 100.0 | 0.0 | 0.0 | 100.0 | 0.0 | 0.0 |
| min | ±0.0 | ±0.0 | ±0.0 | ±0.0 | ±0.0 | ±0.0 | ±0.0 | ±0.0 | ±0.0 | ±0.0 | ±0.0 | ±0.0 | ±0.0 | ±0.0 | ±0.0 | ±0.0 | ±0.0 | ±0.0 |
| 30 | 100.0 | 0.0 | 0.0 | 100.0 | 0.0 | 0.0 | 100.0 | 0.0 | 0.0 | 100.0 | 0.0 | 0.0 | 100.0 | 0.0 | 0.0 | 100.0 | 0.0 | 0.0 |
| min | ±0.0 | ±0.0 | ±0.0 | ±0.0 | ±0.0 | ±0.0 | ±0.0 | ±0.0 | ±0.0 | ±0.0 | ±0.0 | ±0.0 | ±0.0 | ±0.0 | ±0.0 | ±0.0 | ±0.0 | ±0.0 |
| 1 | 100.0 | 0.0 | 0.0 | 100.0 | 0.0 | 0.0 | 100.0 | 0.0 | 0.0 | 100.0 | 0.0 | 0.0 | 100.0 | 0.0 | 0.0 | 100.0 | 0.0 | 0.0 |
| hour | ±0.0 | ±0.0 | ±0.0 | ±0.0 | ±0.0 | ±0.0 | ±0.0 | ±0.0 | ±0.0 | ±0.0 | ±0.0 | ±0.0 | ±0.0 | ±0.0 | ±0.0 | ±0.0 | ±0.0 | ±0.0 |
| 24 | 10.0 | 35.5 | 54.5 | 2.0 | 26.0 | 72.0 | 2.0 | 42.0 | 56.0 | 2.0 | 26.0 | 72.0 | 0.0 | 6.0 | 94.0 | 0.0 | 8.0 | 92.0 |
| hours | ±4.5 | ±2.8 | ±5.5 | ±2.0 | ±6.8 | ±8.6 | ±2.0 | ±7.3 | ±8.1 | ±2.0 | ±7.5 | ±7.3 | ±0.0 | ±4.0 | ±4.0 | ±0.0 | ±3.7 | ±3.7 |
| 48 | 0.0 | 19.5 | 80.5 | 0.0 | 10.0 | 90.0 | 0.0 | 8.0 | 92.0 | 0.0 | 8.0 | 92.0 | 0.0 | 4.0 | 96.0 | 0.0 | 0.0 | 100.0 |
| hours | ±0.0 | ±5.3 | ±5.3 | ±0.0 | ±4.5 | ±4.5 | ±0.0 | ±3.7 | ±3.7 | ±0.0 | ±4.9 | ±4.9 | ±0.0 | ±4.0 | ±4.0 | ±0.0 | ±0.0 | ±0.0 |
| 72 | 0.0 | 9.6 | 90.4 | 0.0 | 0.0 | 100.0 | 0.0 | 0.0 | 100.0 | 0.0 | 0.0 | 100.0 | 0.0 | 0.0 | 100.0 | 0.0 | 0.0 | 100.0 |
| hours | ±0.0 | ±2.9 | ±2.9 | ±0.0 | ±0.0 | ±0.0 | ±0.0 | ±0.0 | ±0.0 | ±0.0 | ±0.0 | ±0.0 | ±0.0 | ±0.0 | ±0.0 | ±0.0 | ±0.0 | ±0.0 |
| 96 | 0.0 | 3.8 | 96.2 | 0.0 | 0.0 | 100.0 | 0.0 | 0.0 | 100.0 | 0.0 | 0.0 | 100.0 | 0.0 | 0.0 | 100.0 | 0.0 | 0.0 | 100.0 |
| hours | ±0.0 | ±2.3 | ±2.3 | ±0.0 | ±0.0 | ±0.0 | ±0.0 | ±0.0 | ±0.0 | ±0.0 | ±0.0 | ±0.0 | ±0.0 | ±0.0 | ±0.0 | ±0.0 | ±0.0 | ±0.0 |

Between 1-hour and 24-hours, all combination treatments converted knockdown and moribund states into complete mortality. A percentage of knocked-down flies with pyrethrin treatments appeared to recover between 1-hour and 24-hours. The following combination treatments appear to be at least additive in moribund state and mortality, of the Qcide and pyrethrin treatments at equivalent application rates alone (no antagonism): Qcide LC₂₅ & pyrethrin LC₂₅, Qcide LC₂₅ & pyrethrin LC₅₀, Qcide LC₅₀ & pyrethrin LC₂₅, Qcide LC₅₀+ pyrethrin LC₅₀ and Qcide LC₇₅+ pyrethrin LC₂₅. The presence of synergy/joint toxicity was calculated using the Concentration Addition (CA) method. All analyses were conducted using R version 3.5.3 (R Development Core Team 2019). Synergy was observed for Qcide LC₂₅+ pyrethrin LC₂₅ (χ²=21.868, p<0.001), Qcide LC₂₅+ pyrethrin LC₅₀ (χ²=15.145, p<0.001) and Qcide LC₅₀+ pyrethrin LC₂₅ (χ²=14.723, p<0.001).

### CONCLUSIONS

All combinations of Qcide and pyrethrin resulted in >90% mortality at 72-hours post spray application. Evidence of synergy was noted when Qcide was used in combination with pyrethrin for treatments Qcide LC₂₅+ pyrethrin LC₂₅, Qcide LC₂₅+ pyrethrin LC₅₀ and Qcide LC₅₀+ pyrethrin LC₂₅.

1. A method for controlling winged insect pests, comprising exposing the pests to an effective amount of a combination of a β-diketone compound of formula (I): 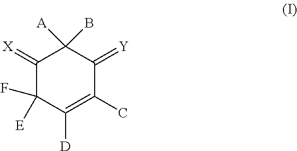
wherein
X and Y are each independently selected from oxygen, sulfur —N—R₄ or one of C═X and C═Y is CH₂;
A is (C═O)R₁, (C═S)R₁, OR₂, SR₂, (CR₃NR₄R₅), C(R₃)₂OR₂, NR₄R₅, (C═N—R₄)R₁, N═O, N(═O)₂, NR₄OR₂ or SO₄R₂;
B is H, C₁-C₁₀ alkyl, C₂-C₁₀ alkenyl, aryl or heteroaryl;
C, D, E and F are each independently selected from H, C₁-C₁₀ alkyl, C₂-C₁₀ arylalkyl, C₃-C₆ cycloalkyl, C₂-C₁₀ alkenyl, C₂-C₁₀ heteroarylalkyl, C₂-C₁₀ haloalkyl, C₂-C₁₀ dihaloalkyl, C₂-C₁₀ trihaloalkyl, C₂-C₁₀ haloalkoxy, OR₂, SR₂, (CR₃NR₄R₅), NR₄R₅, (C═N—R₄)R₁, N═O, N(—O)₂, NR₄OR₂ and SO₄R₂;
R₁ is selected from H, C₁-C₁₀ alkyl, C₂-C₁₀ arylalkyl, C₃-C₆ cycloalkyl, C₂-C₁₀ alkenyl, C₂-C₁₀ heteroarylalkyl, C₁-C₁₀ haloalkyl, C₁-C₁₀ dihaloalkyl, C₂-C₁₀ trihaloalkyl, C₂-C₁₀ haloalkoxy, C₁-C₁₀ hydroxyalkyl, C₁-C₁₀ thioalkyl, C₁-C₁₀ nitroalkyl, OR₂, SR₂, (CR₃NR₄R₅), NR₄R₅, (C═N—R₄)R₆, N═O, N(═O)₂, NR₄OR₇ and SO₄R₇;
R₂ is selected from H, C₁-C₁₀ alkyl, C₂-C₁₀ arylalkyl, C₃-C₆ cycloalkyl, C₂-C₁₀ alkenyl, C₂-C₁₀ heteroarylalkyl, C₂-C₁₀ haloalkyl, C₂-C₁₀ dihaloalkyl, C₂-C₁₀ trihaloalkyl, (CR₃NR₄R₅), NR₄R₅, (C═N—R₄)R₆, N—O, N(═O) 2 and NR₄OR₇;
R₃ is selected from H, C₁-C₁₀ alkyl, C₂-C₁₀ arylalkyl, C₃-C₆ cycloalkyl, C₂-C₁₀ alkenyl, C₂-C₁₀ heteroarylalkyl, C₂-C₁₀ haloalkyl, C₂-C₁₀ dihaloalkyl, C₂-C₁₀ trihaloalkyl, C₂-C₁₀ haloalkoxy, OR₇, SR₇, (CR₈NR₄R₅), NR₄R₅, (C═N—R₄)R₆, N═O, N(═O)₂, NR₄OR₇ and SO₄R₇;
R₄ and R₅ are independently selected from H, C₁-C₁₀ alkyl, C₂-C₁₀ arylalkyl, C₃-C₆ cycloalkyl, C₂-C₁₀ alkenyl, C₂-C₁₀ heteroarylalkyl, C₂-C₁₀ haloalkyl, C₂-C₁₀ dihaloalkyl, C₂-C₁₀ trihaloalkyl, OR₇ and SR₇;
R₆ is selected from H, C₁-C₁₀ alkyl, C₂-C₁₀ arylalkyl, C₃-C₆ cycloalkyl, C₂-C₁₀ alkenyl, C₂-C₁₀ heteroarylalkyl, C₂-C₁₀ haloalkyl, C₂-C₁₀ dihaloalkyl, C₂-C₁₀ trihaloalkyl, C₂-C₁₀ haloalkoxy, OR₇, SR₇, (CR₈NR₉R₁₀), NR₉N₁₀ and NR₉OR₇;
R₇ is selected from H, C₁-C₁₀ alkyl, C₂-C₁₀ arylalkyl, C₃-C₆ cycloalkyl, C₂-C₁₀ alkenyl, C₂-C₁₀ heteroarylalkyl, C₂-C₁₀ haloalkyl, C₂-C₁₀ dihaloalkyl, C₂-C₁₀ trihaloalkyl;
R₈ is selected from H, C₁-C₁₀ alkyl, C₂-C₁₀ arylalkyl, C₃-C₆ cycloalkyl, C₂-C₁₀ alkenyl, C₂-C₁₀ heteroarylalkyl, C₂-C₁₀ haloalkyl, C₂-C₁₀ dihaloalkyl, C₂-C₁₀ trihaloalkyl, OR₁₁, SR₁₁ and NR₉R₁₀;
R₉ and R₁₀ are independently selected from H, C₁-C₁₀ alkyl, C₂-C₁₀ arylalkyl, C₃-C₆ cycloalkyl, C₂-C₁₀ alkenyl, C₂-C₁₀ heteroarylalkyl, C₂-C₁₀ haloalkyl, C₂-C₁₀ dihaloalkyl, C₂-C₁₀ trihaloalkyl, OR₁₂ and SR₁₂;
R₁₁ and R₁₂ are independently selected from H, C₁-C₁₀ alkyl, C₂-C₁₀ arylalkyl, C₃-C₆ cycloalkyl, C₂-C₁₀ alkenyl, C₂-C₁₀ heteroarylalkyl, C₂-C₁₀ haloalkyl, C₂-C₁₀ dihaloalkyl and C₂-C₁₀ trihaloalkyl;
and at least one second pesticide selected from a pyrethroid or a pyrethrin, wherein both the β-diketone compound of formula (I) and the at least one second pesticide is used in a sub-effective amount.

2. The method of claim 1, wherein the compound of formula (I) is selected from a compound of structural formula:

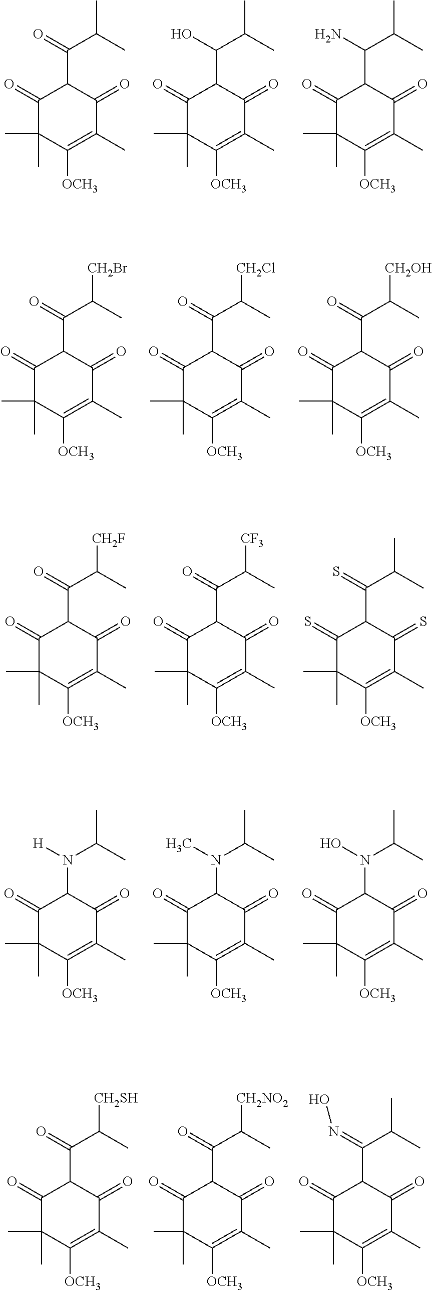

3. The method of claim 1, wherein the compound of formula (I) is selected from tasmanone (1-isobutyroyl-4 methoxy-3,5,5-trimethylcyclohex-3-en-2,6-dione), agglomerone (1-isobutyroyl-4-methoxy-5,5-dimethylcyclohex-3-en-2,6-dione), lateriticone (1-valeroyl-4-methoxy-3,5,5-trimethylcyclohex-3-en-2,6-dione), isolateriticone (1-isovaleroyl-4-methoxy-3,5,5-trimethylcyclohex-3-en-2,6-dione) and platyphyllol (6,6-dimethyl-2-acetyl-5-methoxycyclohex-4-ene-1,3-dione).

4. The method of claim 1, wherein the compound of formula (I) is tasmanone (1-isobutyroyl-4 methoxy-3,5,5-trimethylcyclohex-3-en-2,6-dione).

5. The method of claim 1, wherein the second pesticide is a pyrethroid selected from acrinathrin, allethrin, bifenthrin, bioallethrin, bioallethrin-S-cyclopentyl, bioresmethrin, cycloprothrin, cyfluthrin, β-cyfluthrin, cyhalothrin, γ-cyhalothrin, λ-cyhalothrin, cypermethrin, α-cypermethrin, β-cypermethrin, θ-cypermethrin, ζ-cypermethrin, cyphenothrin, deltamethrin, dimefluthrin, empenthrin, esfenvalerate, etofenprox, fenpropathrin, fenvalerate, flucythrinate, flumethrin, fluvalinate, tau-fluvalinate, halfenprox, imiprothrin, metofluthrin, permethrin, phenothrin, prallethrin, profluthrin, pyrethrin (pyrethrum), resmethrin, RU15525, silafluofen, tefluthrin, tetramethrin, tralomethrin, transfluthrin and ZX18901.

6. The method of claim 1, wherein the second pesticide is selected from permethrin, deltamethrin and cypermethrin.

7. The method of claim 1, wherein the second pesticide is a pyrethrin selected from pyrethrin I, cinerin I, jasmolin I, pyrethrin II, cinerin II and jasmolin II.

8. The method of claim 1, wherein the winged insect pests are permethrin-resistant.

9. The method of claim 1, wherein the winged insect pests are selected from the order of Lepidoptera, Coleoptera, Diptera, Thysanoptera, Hymenoptera, Hemiptera, Heteroptera, Homoptera, Isoptera, Blattoidae, Orthoptera, Phthiraptera, Siphonaptera, Thysanura, Dermaptera and Psocoptera.

10. The method of claim 1, wherein the winged insect pests are selected from the order of Diptera.

11. The method of claim 1, wherein the winged insect pests are selected from the genus Anastrepha, Ceratitis, Contarinia, Dacus, Dasineura, Delia, Hydrellia, Hyleniyia, Liriomyza, Mayetiola, Orseolia, Oscinella, Pegomya, Phorbia, Rhagoletis, Aedes, Anopheles, Chrysomya, Cochliomyia, Cordylobia, Culex, Fannia, Gasterophilus, Glossina, Haernatobia, Haplodiplosis, Hypoderma, Lucilia, Musca, Muscina, Oestrus, Tabanus and Simulium.

12. The method of claim 1, wherein the winged insect pests are selected from the genus Culex, and Aedes.

13. The method of claim 1, wherein both the β-diketone compound of formula (I) and the at least one second pesticide is used in a sub-additive amount.

14. The method of claim 1, wherein
controlling the winged insect pests is by way of incapacitation, preferably death.

15. A composition for controlling winged insect pests, comprising a β-diketone compound of formula (I) as defined in claim 1, and at least one second pesticide selected from a pyrethroid or a pyrethrin, wherein both of the β-diketone compound and the at least one pyrethroid or pyrethrin are included in a sub-effective amount.

16. The composition of claim 15, wherein both of the β-diketone compound and the at least one pyrethroid or pyrethrin are included in a sub-additive amount.

17. The composition of claim 16, wherein the β-diketone compound of formula (I) is included in an amount of from an LC₅ to an LC₂₅ amount and the at least one pyrethroid or pyrethrin is included in an amount of from about an LC₄₀ to about an LC₆₀ amount, or the β-diketone compound of formula (I) is included in an amount of from an LC₁₅ to an LC₆₀ amount and the at least one pyrethroid or pyrethrin is included in an amount of from an LC₁₅ to an LC₆₀ amount.

18. A kit for use in a method for controlling winged insect pests, comprising a β-diketone compound of formula (I) as defined in claim 1, and at least one second pesticide selected from a pyrethroid or a pyrethrin, together with instructions to expose winged insect pests to a combination of the β-diketone compound of formula (I) and at least one pyrethroid or pyrethrin using both of the β-diketone compound and pyrethroid or pyrethrin in a sub-effective amount.
